(19) United States
(12) Patent Application Publication
(10) Pub. No.: US 2023/0240459 A1
(43) Pub. Date: Aug. 3, 2023

(54) DISMOUNTABLE PUMP SYSTEM AND METHOD

(71) Applicant: X ROBOTICS, INC., San Francisco, CA (US)

(72) Inventors: Denis Rodionov, San Francisco, CA (US); Roman Sharapov, San Francisco, CA (US)

(21) Appl. No.: 18/297,473

(22) Filed: Apr. 7, 2023

Related U.S. Application Data
(63) Continuation-in-part of application No. 17/475,293, filed on Sep. 14, 2021.
(60) Provisional application No. 63/362,670, filed on Apr. 8, 2022.

(51) Int. Cl. A47G 19/18; F04C 2/18

(52) U.S. Cl. CPC A47G 19/183; F04C 2/18; F04C 2240/30

(57) ABSTRACT

A dismountable pump system for quick and efficient cleaning of all pump components. The system includes a container associated with a back pump unit, a pump unit, a fastener and a lock member. The back pump unit defines a flow bore in fluid communication with an interior cavity of the container. The pump unit is removably attached to the back pump unit allowing for disassembly. The pump unit includes a pumping chamber in fluid communication with the flow bore when the pump unit is mounted to the back pump unit. The fastener is pivotably associated with the back pump unit, and the lock member is pivotably associated with the pump unit. The fastener can be pivoted to a locked position to secure the pump unit to the back pump unit, and an unlocked position to allow the pump unit to be removed from the back pump unit.

### CROSS-REFERENCE TO RELATED APPLICATION

This application claims the benefit of priority under 35 U.S.C. § 119(e) based upon co-pending U.S. provisional patent application Ser. No. 63/362,670 filed on Apr. 8, 2022, the entire contents of which is incorporated herein by reference.

This application is a continuation-in-part under 35 U.S.C. § 120 based upon co-pending U.S. patent application Ser. No. 17/475,293 filed on Sep. 14, 2021, the entire contents of which is incorporated herein by reference.

### BACKGROUND

### Technical Field

In some aspects, the present technology relates to a pump system. In some other aspects, the present technology relates to methods associated with a pump system. In other aspects, the present technology relates to a pump system for providing a fluid ingredient to an automatic food processing machine. In some other aspects, the present technology relates to a sauce dispenser and/or method of dispensing sauce utilizing a pump system. In still some other aspects, the present technology relates to an ingredient pump system and/or method for preparing a pizza for cooking.

### Background Description

Motorized and hand pump dispensers for applying a liquid or semi-liquid food product are known. These known dispenser are specifically utilized to deliver a liquid or semi-liquid food product, such as tomato sauce, on to a pizza crust in the making of pizza. The dispenser typically include a motor driven pump that is either integrally formed with a sauce container or remote therefrom utilizing a drawtube.

### SUMMARY

In view of the disadvantages inherent in the known types of pumps, at least some embodiments of the present technology provides a novel dismountable pump system and method, and overcomes one or more of the mentioned disadvantages and drawbacks of the prior art. As such, the general purpose of at least some embodiments of the present technology, which will be described subsequently in greater detail, is to provide a new and novel pump system and method which has all the advantages of the prior art mentioned herein and many novel features that result in a pump system and method which is not anticipated, rendered obvious, suggested, or even implied by the prior art, either alone or in any combination thereof.

According to one embodiment, the present technology can include a pump unit for removably mounting to a discharge section of a container. The pump unit can include a pump housing and a fastener. The pump housing can include a pumping chamber defined therein. When the pump unit is mounted to the discharge section of the container, the pumping chamber is in fluid communication with the discharge section of the container and the pump unit is secured to the discharge section by the fastener in a locked position. When the pump unit is removed from the discharge section of the container, the fastener is in an unlocked position.

According to another embodiment, the present technology can include a pump unit for removably mounting to a discharge section of a container by way of a fastener. The pump unit can include a pump housing and a fastener receiving surface. The pump housing can include a pumping chamber defined therein. When the pump unit is mounted to the discharge section of the container, the pumping chamber is in fluid communication with the discharge section of the container and the pump unit is secured to the discharge section by the fastener in a locked position with the fastener receiving surface. When the pump unit is removed from the discharge section of the container, the fastener is in an unlocked position with the fastener receiving surface.

According to yet another embodiment, the present technology can include a pump system including a pump unit, and one or more fasteners. The pump unit can be configured to be removably mountable to a discharge section of a container. The pump unit can include a pumping chamber defined therein, with the pumping chamber being in fluid communication with a flow bore defined through the discharge section when the pump unit is mounted to the discharge section. The fasteners can be configured to secure the pump unit to the discharge section in a locked position and allow the pump unit to be removed from the discharge section in an unlocked position.

According to still another embodiment, the present technology can include a pump system including a pump unit and one or more latches. The pump unit can be configured to be removably mountable to a discharge section of a container. The pump unit can include a back pump section configured to mate with the discharge section, a front pump section extending from the back pump section, a first rotor chamber, a second rotor chamber and a pumping chamber each defined in the pump unit. The first rotor chamber, the second rotor chamber and the pumping chamber can all be in fluid communication with each other. The pumping chamber can be in fluid communication with a flow bore defined through the discharge section when the pump unit is mounted to the discharge section. A first rotor can be rotatably received in the first rotor chamber. The latches can be configured to secure the pump unit to the discharge section in a locked position and allow the pump unit to be removed from the discharge section in an unlocked position.

According to still yet another embodiment, the present technology can include a pump system including a container, a pump unit, a drive shaft assembly and one or more latches. The container can be configured to contain a pumpable material, and can include an angled bottom wall that is sloped toward a flow bore defined through a discharge section. The pump unit can be configured to be removably mountable to a discharge section of a container. The pump unit can include a back pump section configured to mate with the discharge section, a front pump section extending from the back pump section, a first rotor chamber, a second rotor chamber and a pumping chamber each defined in the pump unit. The first rotor chamber, the second rotor chamber and the pumping chamber can all be in fluid communication with each other. The pumping chamber can be in fluid communication with a flow bore defined through the discharge section when the pump unit is mounted to the discharge section. A first rotor can be rotatably received in the first rotor chamber. The drive shaft assembly can include a drive shaft, a first rotary seal, a bearing and a second rotary seal. The drive shaft can be operatively driven by a motor, and can be configured to pass through a shaft bore defined through the front pump section and into the first rotor chamber. The first rotor can be attachable to a first end of the drive shaft. The first rotary seal can be receivable in the shaft bore and operatively engaged with the drive shaft. The bearing can be receivable in the shaft bore and operatively engaged with the drive shaft. The second rotary seal can be receivable in the shaft bore and operatively engaged with the drive shaft. The bearing can be located between the first rotary seal and the second rotary seal. The latches can be configured to secure the pump unit to the discharge section in a locked position and allow the pump unit to be removed from the discharge section in an unlocked position.

According to yet still another embodiment, the present technology can include a method of removably mounting a pump unit to a discharge section of a container by way of a fastener. The pump unit can include a pumping chamber defined therein. The method can include the steps of positioning the pump unit against the discharge section of the container so that the pumping chamber is in fluid communication with a flow bore defined through the discharge section. Securing the pump unit to the container when the fastener is in a locked position. Removing the pump unit from the discharge section of the container when the fastener is in an unlocked position.

According to yet still another embodiment, the present technology can include a container for removably mounting a pump unit thereto. The container can include a discharge section and a fastener. The pump unit can include a pumping chamber defined therein. When the discharge section of the container is mounted with the pump unit, a pumping chamber of the pump unit is in fluid communication with the discharge section of the container and the container is secured with the pump unit by the fastener in a locked position. When the pump unit is removed from the discharge section, the fastener is in an unlocked position.

According to another embodiment, the present technology can include a container for removably mounting to a pump unit thereto by way of a fastener. The container can include discharge section and a fastener receiving surface. When the discharge section of the container is mounted with the pump unit, a pumping chamber of the pump unit is in fluid communication with the discharge section of the container and the pump unit is secured to the discharge section by the fastener in a locked position with the fastener receiving surface. When the pump unit is removed from the discharge section of the container, the fastener is in an unlocked position with the fastener receiving surface.

According to one aspect, the present technology can include a pump system including a back pump unit, a pump unit, a latch and a lock member. The back pump unit can be associated with a container. The back pump unit can define a flow bore therethrough that is in communication with an interior cavity of the container. The pump unit can be configured to be removably mountable with the back pump unit. The pump unit can include a pumping chamber defined in the pump unit that can be in communication with the flow bore of the back pump unit when the pump unit is mounted to with the back pump unit. The latch can be pivotably associated with the back pump unit. The lock member can be pivotably associated with the pump unit. The latch can be pivotable to a locked position configured to secure the pump unit to the back pump unit, and an unlocked position configured to allow the pump unit to be removed from the back pump unit. The latch can include a latch end portion that can be configured to engage with a lock end portion of the lock member in the locked position.

According to another aspect, the present technology can include a pump system for a food preparation machine. The pump system can include a container, a back pump unit, a pump unit, a latch and a lock member. The container can include a container body defining an open end and an interior cavity configured to receive a liquid usable with the food preparation machine. The container being configured to be mountable with the food preparation machine. The back pump unit can be associated with the container. The back pump unit can define a flow bore therethrough that is in communication with the interior cavity of the container. The pump unit can be configured to be removably mountable with the back pump unit. The pump unit can include a pumping chamber defined in the pump unit that can be in communication with the flow bore of the back pump unit when the pump unit is mounted to with the back pump unit. The latch can be pivotably associated with the back pump unit. The lock member can be pivotably associated with the pump unit. The latch can be pivotable to a locked position configured to secure the pump unit to the back pump unit, and an unlocked position configured to allow the pump unit to be removed from the back pump unit. The latch can include a latch end portion that can be configured to engage with a lock end portion of the lock member in the locked position.

According to yet another aspect, the present technology can include a pump system. The pump system can be associated with a food preparation machine, and can include a container, a back pump unit, a pump unit, a latch and a lock member. The container can include a container body defining an open end and an interior cavity configured to receive a liquid usable with the food preparation machine. A mounting bracket can be configured to removably mount the container to a frame structure of the food preparation machine. The back pump unit can be associated with the container. The back pump unit can define a flow bore therethrough that is in communication with the interior cavity of the container. The pump unit can be configured to be removably mountable with the back pump unit. The pump unit can include a pumping chamber defined in the pump unit that can be in communication with the flow bore of the back pump unit when the pump unit is mounted to with the back pump unit. The latch can be pivotably associated with the back pump unit. The lock member can be pivotably associated with the pump unit. The latch can be pivotable to a locked position configured to secure the pump unit to the back pump unit, and an unlocked position configured to allow the pump unit to be removed from the back pump unit. The latch can include a latch end portion that can be configured to engage with a lock end portion of the lock member in the locked position. One of or any combination of the latch and the lock member can be configured to provide a biasing force in the locked position that is configured to act on the lock member to pull the pump unit toward the back pump unit.

According to still another one aspect, the present technology can include a method of removing a demountable pump system from a container. The method can include the steps of providing a back pump unit associated with the container, a pump unit mountable to the back pump unit, a latch pivotably associated with the pump back unit, and a lock member pivotably associated with the pump unit. The back pump unit can define a flow bore therethrough that is in communication with an interior cavity of the container. The pump unit can include a pumping chamber defined in the pump unit that can be in communication with the flow bore of the back pump unit when the pump unit is mounted to with the back pump unit. Pivoting the latch from a locked position with the lock member to an unlocked position, with the locked position securing the pump unit to the back pump unit, and the unlocked position allows the pump unit to be removed from the back pump unit. Rotating of the lock member by the pivoting of the latch so that a latch end portion of the latch moves a lock end portion of the lock member. Releasing the latch end portion of the latch form the lock end portion of the looking member upon further pivoting of the latch away from the lock member.

In some or all embodiments, the pump unit can include a back pump section mountable to the discharge section.

In some or all embodiments, the pump unit can include a front pump section extending from the back pump section.

Some or all embodiments can include a first rotor rotatably located in a first rotor chamber, and a second rotor rotatably located in a second rotor chamber. The first rotor chamber, the second rotor chamber and the pumping chamber can all be in fluid communication with each other.

Some or all embodiments can include a seal in juxtaposition with the first rotor chamber, the second rotor chamber and the pumping chamber. The seal can form a sealed contact between the discharge section and the back pump section when the fastener is in the locked position.

In some or all embodiments, the front pump section can include a shaft extending into the second rotor chamber. The shaft can rotatably locate the second rotor in the second rotor chamber.

In some or all embodiments, the first rotor and the second rotor can be counter rotating and configured to pump a liquid from the pumping chamber to a discharge port of the pump housing or unit.

Some or all embodiments can include a drive shaft configured to pass through a shaft bore defined through the front pump section and into the first rotor chamber. The first rotor can be attachable to a first end of the drive shaft that is operatively driven by a motor.

Some or all embodiments can include a first rotary seal located in the shaft bore and operatively engaged with the drive shaft.

Some or all embodiments can include a bearing located in the shaft bore and operatively engaged with the drive shaft.

Some or all embodiments can include a second rotary seal located in the shaft bore and operatively engaged with the drive shaft.

In some or all embodiments, the bearing can be located between the first rotary seal and the second rotary seal.

In some or all embodiments, the drive shaft can include a stop ledge extending out therefrom and configured adjacent to the bearing.

Some or all embodiments can include a threaded member configured to secure a cog or cog socket to a second end of the drive shaft. The cog or cog socket can be operatively engageable with a motor.

In some or all embodiments, the back pump section can include one or more guides extending therefrom and receivable in guide holes defined in the discharge section.

In some or all embodiments, the container can include an angled bottom wall that is sloped toward the flow bore of the discharge section.

In some or all embodiments, the container can include feet extending from a bottom side thereof for supporting the container, and a hand grip.

In some or all embodiments, the fastener can be a latch.

In some or all embodiments, the latch is engageable with a fastener receiving surface.

In some or all embodiments, the latch is on a side of the pump unit adjacent to a mounting side of the pump unit. The mounting side faces the discharge end when the pump unit is secured to the discharge section.

In some or all embodiments, the fastener receiving surface is located on a side of the container adjacent to the discharge section.

In some or all embodiments, the fastener receiving surface can be on a side of the pump unit adjacent to a mounting side of the pump unit. The mounting side faces the discharge end when the pump unit is secured to the discharge section.

In some or all embodiments, the latch is on a side of the container adjacent to the discharge section.

In some or all embodiments, the discharge section is perpendicular to a bottom wall of the container.

Some or all embodiments of the present technology can include a flow bore defined through the discharge section.

In some or all embodiments, the flow bore and the pumping chamber are perpendicular to a plane defining the discharge section when in the locked position.

In some or all embodiments, the pump unit includes a discharge port defined in a discharge nozzle extending from the pump unit. The discharge port is parallel with a plane that defines the discharge section when in the locked position.

In some or all embodiments, when in the locked position, the pumping chamber is configured to receive a fluid in a direction that is perpendicular to a pumping direction provided by the first and second rotors.

In some or all embodiments, when in the locked position, the first and second rotors are configured to rotate about an axis that is parallel with a plane that defines the flow bore and the pumping chamber.

In some or all embodiments, when in the locked position, the first and second rotors are configured to rotate about an axis that is perpendicular to a plane that defines the discharge section.

In some or all embodiments, the back pump unit can include a pair of spaced apart latch support members defining a latching gap therebetween with the latch being pivotably received in the latching gap. The latch being pivotably engaged with each of the latch support members.

In some or all embodiments, the pump unit can include a pair of spaced apart locking support members defining a locking gap therebetween with the lock member being pivotably received in the locking gap. The lock member being pivotably engaged with each of the locking support members.

In some or all embodiments, the latch end portion of the latch can include a hook section defining a lock notch.

In some or all embodiments, the lock end portion of the lock member can include a lock end configured to be received in the lock notch when the latch and the lock member are in the locked position.

In some or all embodiments, the latch can include one or more arched sections that can be configured to provide a biasing force that pulls the hook section of the latch toward the lock end of the lock member when in the locked position.

In some or all embodiments, the latch can have a length configured to act against the lock member when in the locked position to secure the pump unit against the back pump unit.

In some or all embodiments, the lock member can have a length configured so that a hook section of the latch acts against a lock end of the lock member when in the locked position to secure the pump unit against the back pump unit.

In some or all embodiments, the lock member can include a retention end opposite to the lock end. The retention end can be configured to contact a side of the pump unit to prevent the lock end from pivoting past a predetermined distance away from the pump unit in the unlocked position.

In some or all embodiments, the pump unit can include at least two counter rotating lobe rotors configured to pump a liquid from the pumping chamber to a discharge port of the pump unit.

In some or all embodiments, at least one of the lobe rotors can be engaged with a pump shaft that can be configured to engage with a cog located exterior of the pump unit.

Some or all embodiments of the present technology can include a cog socket operably engaged with a motor. The cog socket can be configured to engageably receive the cog to drive the cog upon operation by the motor.

In some or all embodiments, the container can include an angled bottom wall that is sloped toward the flow bore of the back pump unit.

There has thus been outlined, rather broadly, features of at least some embodiments of the present technology in order that the detailed description thereof that follows may be better understood and in order that the present contribution to the art may be better appreciated.

Numerous objects, features and advantages of at least some embodiments of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology. It is, therefore, that the claims be regarded as including such equivalent constructions insofar as they do not depart from the spirit and scope of the present technology.

It is therefore an object of at least some embodiments of the present technology to provide a new and novel pump system and method that has all of the advantages of known dismountable pumps and none of the disadvantages.

It is another object of at least some embodiments of the present technology to provide a new and novel pump system and method that may be easily and efficiently manufactured and marketed.

An even further object of at least some embodiments of the present technology is to provide a new and novel pump system and method that has a low cost of manufacture with regard to both materials and labor, and which accordingly is then susceptible of low prices of sale to the consuming public, thereby making such pump system and method economically available to the buying public.

Still another object of at least some embodiments of the present technology is to provide a new pump system and method that provides in the apparatuses and methods of the prior art some of the advantages thereof, while simultaneously overcoming some of the disadvantages normally associated therewith.

These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the claimed present technology is not limited to meeting most or all of the objects identified and that some embodiments of the present technology may meet only one such object or none at all.

### BRIEF DESCRIPTION OF THE DRAWINGS

The present technology will be better understood and objects other than those set forth above will become apparent when consideration is given to the following detailed description thereof. Such description makes reference to the annexed drawings wherein:

FIG. 1 is a top-left perspective view of an embodiment of the pump system constructed in accordance with the principles of the present technology.

FIG. 2 is a top-right perspective view of the pump system of FIG. 1

FIG. 3 is a top-left exploded perspective view of the pump system of FIG. 1.

FIG. 4 is a top-right perspective view of the back pump unit and the front pump unit of the pump system of FIG. 1 according to one embodiment.

FIG. 5 is a top-left perspective view of the back pump unit and the front pump unit of the pump system of FIG. 1 according to one embodiment.

FIG. 6 is a perspective view of the lobe rotor of the lobe pump unit of the pump system of FIG. 1 according to one embodiment.

FIG. 7 is a perspective view of the lobe pump shaft engageable with the lobe rotor of the pump system of FIG. 1 according to one embodiment.

FIG. 8 is a cross-sectional view of the lobe pump unit taken along line 8-8 in FIG. 1.

FIG. 9 is a cross-sectional view of the pump system taken along line 9-9 in FIG. 1.

FIG. 10 is a cross-sectional view of the pump system taken along line 10-10 in FIG. 1.

FIG. 11A is a top plane view of the latch and the lock member in the unlocked position.

FIG. 11B is a top plane view of the latch being moved to the locked position.

FIG. 11C is a top plane view of the latch and the lock member in the locked position with the lock member pivoted into the locked position.

FIG. 12 is a back and front perspective view of the pump shaft cog of the pump system of FIG. 1 according to one embodiment.

FIG. 13 is a back and front perspective view of the cog socket of the pump system of FIG. 1 according to one embodiment;

FIG. 14 is a top-left perspective view of an embodiment of the pump system constructed in accordance with the principles of the present technology.

FIG. 15 is a bottom-right perspective view of the pump system of FIG. 14.

FIG. 16 is a top-left perspective view of the pump system of FIG. 14 with the pump unit dismounted from the container and exploded, and the container with a cut-away section.

FIG. 17 is a front perspective view of the pump unit of the pump system of FIG. 14 according to one embodiment.

FIG. 18 is a rear perspective view of the pump unit of FIG. 17.

FIG. 19 is a rear exploded perspective view of the pump unit of FIG. 17.

FIG. 20 is a cross-section view of the pump unit taken along line 20-20 in FIG. 18.

FIG. 21 is a cross-section view of the pump unit taken along line 21-21 in FIG. 14.

FIG. 22 is an exploded perspective view of the drive shaft assembly of FIG. 21.

FIG. 23 is a cross-section view of the pump unit taken along line 23-23 in FIG. 17.

The same reference numerals refer to the same parts throughout the various figures.

### DETAILED DESCRIPTION OF THE EMBODIMENTS

Apart from the cumbersomeness of known dispensers, they are not easily capable of being disassembled for cleaning and/or repair. If left uncleaned for a period of time, the sauce in the pump and/or conduits can begin to grow bacteria. Continued operation would then transfer the bacteria to the pizza and thereafter eaten by the consumer. This causes an extremely dangerous health risk.

The USDA says food that has been left out of the fridge for more than two hours should be thrown away. Consequently, these known pump dispensers should be disassembled and cleaned every couple of hours. Further, it can take considerable time to disassembly these known pump dispensers for cleaning, which leads to down time of the food preparation machine causing loss of revenue.

While the above-described devices fulfill their respective, particular objectives and requirements, the aforementioned devices or systems do not describe a pump system and method that allows pumping a fluid utilizing a dismountable pump housing assembly.

A need exists for a new and novel pump system and method that can be used for pumping a fluid utilizing a dismountable pump housing assembly. In this regard, the present technology substantially fulfills this need. In this respect, the pump system and method according to the present technology substantially departs from the conventional concepts and designs of the prior art, and in doing so provides an apparatus primarily developed for the purpose of pumping a fluid utilizing a dismountable pump housing assembly.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

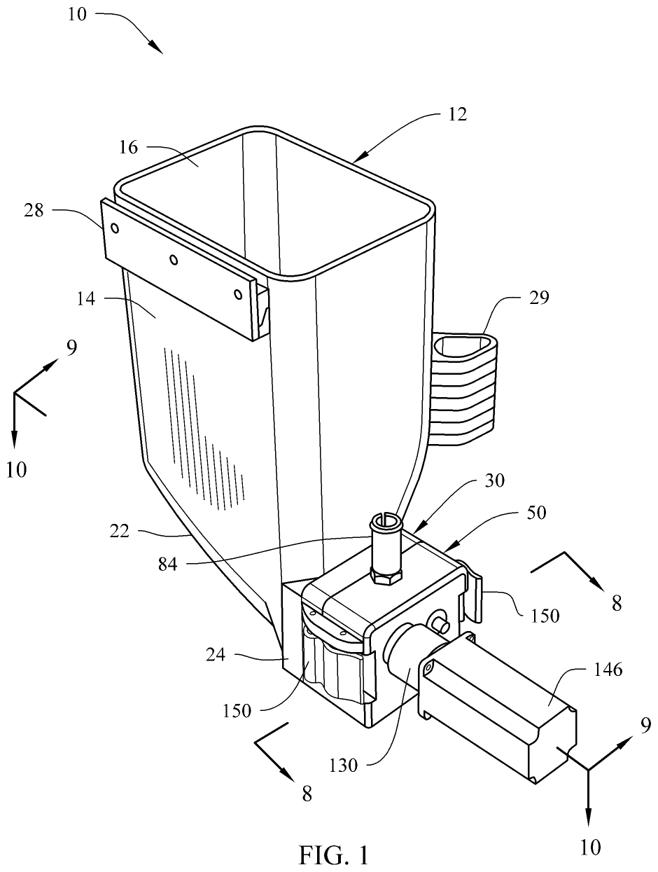

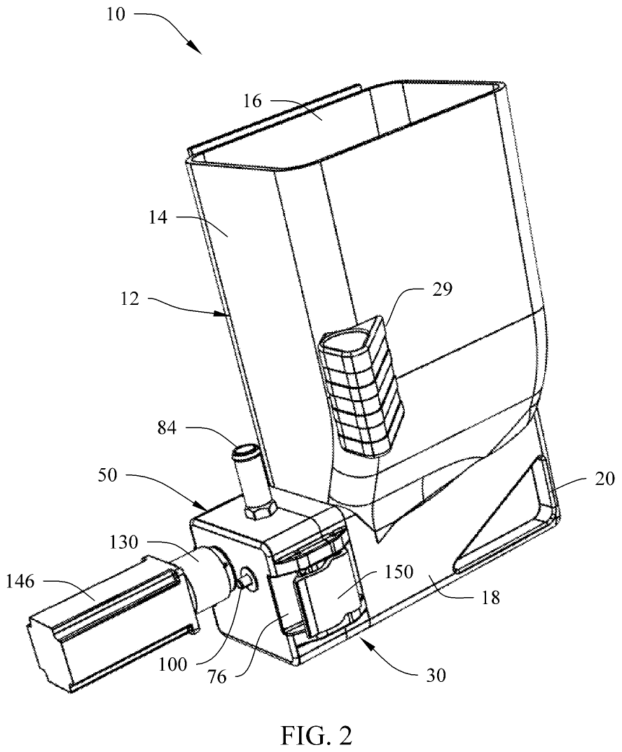

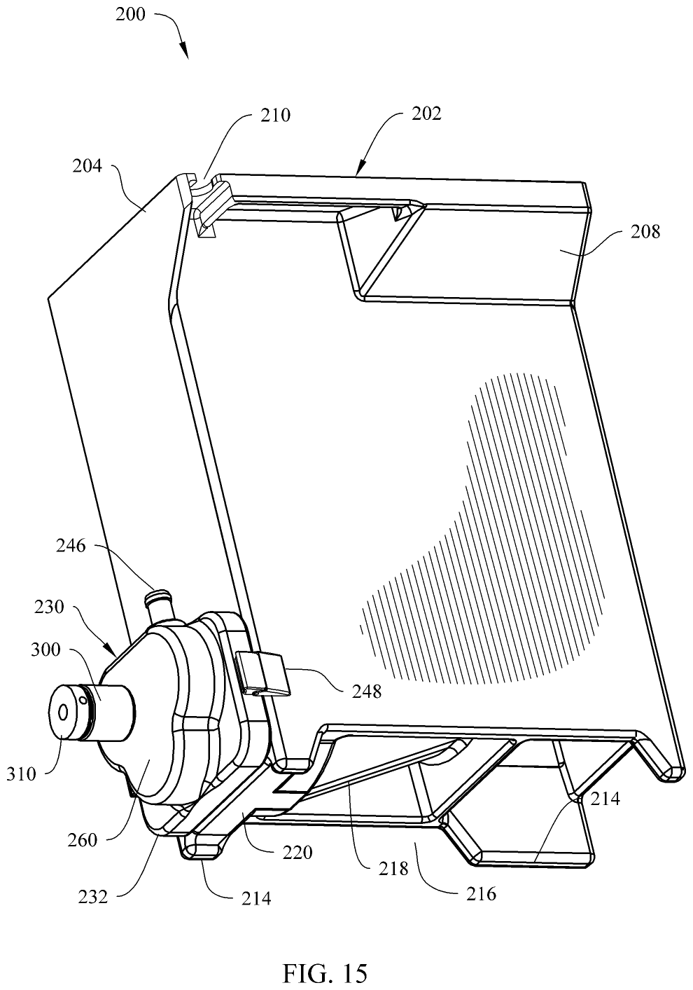

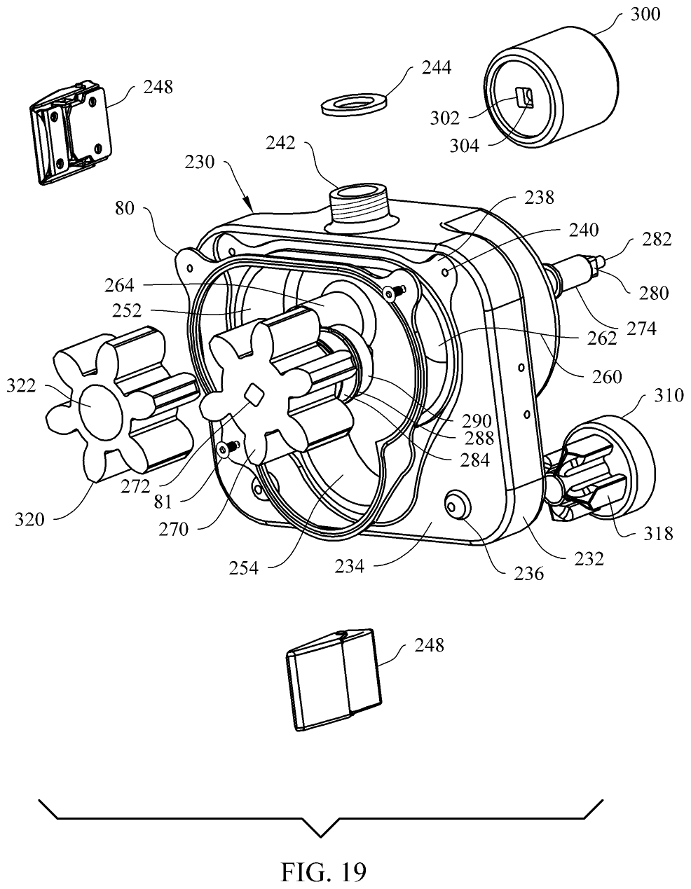

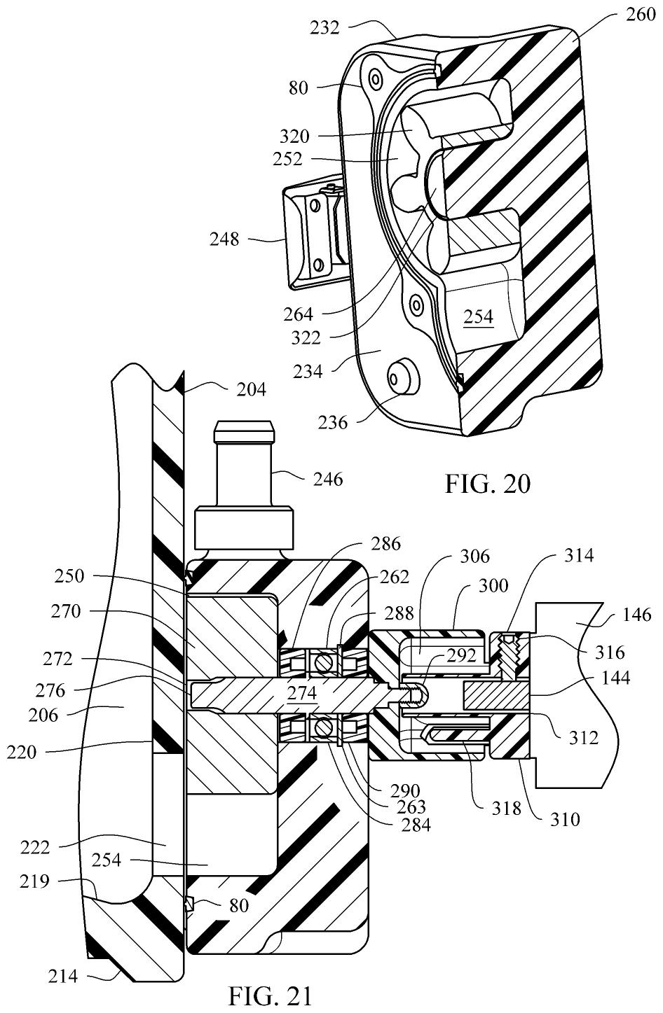

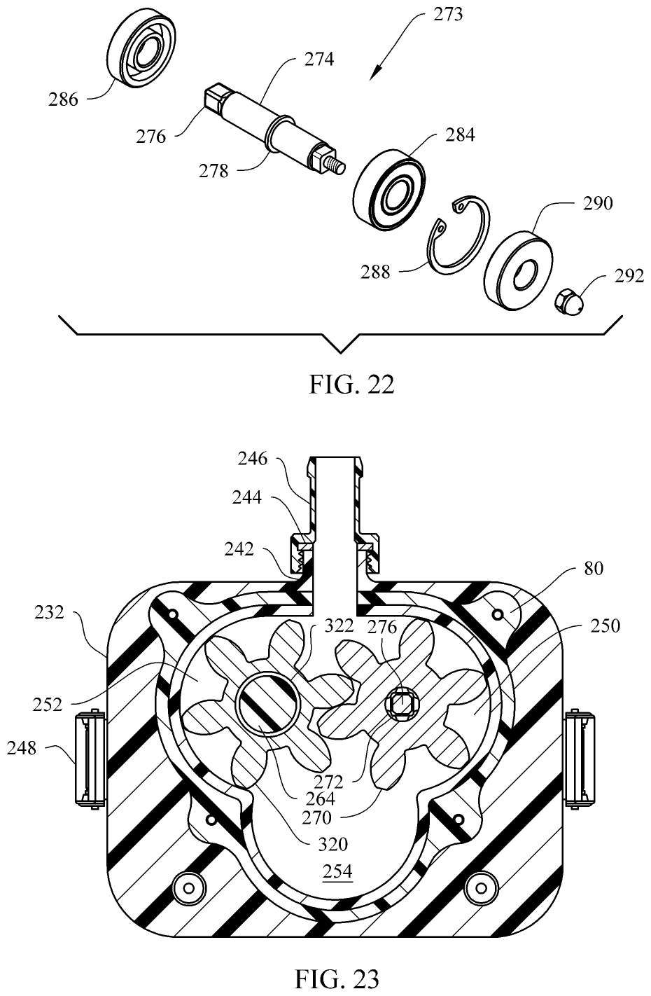

Referring now to the drawings, and particularly to FIGS. 1-23, new and novel dismountable pump units or systems are provided according to some embodiments. The pump system can include a pump unit configured to be removably mountable to a discharge section of a container. The pump unit can include a pumping chamber defined therein that is in fluid communication with a flow bore defined through the discharge section when the pump unit is mounted to the discharge section.

Referring now to the drawings, and particularly to FIGS. 1-13, an embodiment of the pump system and method of the present technology is shown and generally designated by the reference numeral 10.

In FIG. 1, a new and novel dismountable pump system 10 of the present technology for pumping a fluid utilizing a dismountable pump housing assembly is illustrated and will be described. More particularly, the dismountable pump system 10 can include a container 12, a back pump unit 30, a pump unit 50, a pair of latches 150 capable of locking the pump unit 50 to the back pump unit 30, and a cog socket 130 driven by a motor 146 for operation of the pump unit 50.

In an exemplary operation without limiting the scope of the present technology, the pump system 10 can be configured to provide a liquid sauce to a sauce smearing device of a food preparation machine that dispenses a dose of sauce on a pizza dough or other type of food. In the exemplary, the container 12 can be utilized with or in a dispenser unit of a food preparation machine such as, but not limited to, an automated pizza making machine. It can be appreciated that the pump system 10 can be a module unit configured to be placed in different locations in a food preparation machine, and can include modular components for repair and/or upgrading to other components.

The container 12, as best illustrated in FIGS. 1-3 and 6, can include a container body 14 featuring sidewalls defining an open top end and an interior cavity 16, a sloped or angled bottom wall 22, a base section 18, and a mounting flange 24. The container 12 can be made of, but not limited to, plastic, metals, alloys, composites, and the like. A liquid or semiliquid such as, but not limited, sauces, creams, marinates, pastes, and the like, can be stored in the cavity 16 for use with the back pump unit 30 and the pump unit 50 so as to be pumped from a bottom section of the container 12 for use with other components.

The base section 18 can include a handle portion 20 configured to be grasped by a user for manipulation of the pump system 10 and/or the container 12. The handle portion 20 can include an opening therethrough allowing fingers or a hand of the user to grasp the handle portion 20. The base section 18 and/or the handle portion 20 can extend from the angled bottom wall 22, and can have a flat planar bottom edge. The flat planar bottom edge of the base section 18 and/or handle portion 20 can be configured to allow the pump system 10 or the container 12 to be supported vertically on a surface. This allows for work to be performed on the pump system 10 more easily.

A mounting bracket 28 can be attachable to an exterior of one of the sidewalls of the container body 14, thereby allowing the pump system 10 to be mountable to a frame structure. In the exemplary, the mounting bracket 28 can be configured to engage with or be receive in the tracks of a corresponding frame member, thereby supporting and/or positioning the container 12 in a predetermined location within the food preparation machine.

An additional mounting member 29 can be utilized to support the container 12 with the frame structure or other component of the food preparation machine. Alternatively, the mounting member 29 can include a bore therethrough configured to guide and/or support tubes or hoses associated with filling of the container 12 and/or dispensing from the pump unit 50.

The angled bottom wall 22 is configured to slope downwardly towards the mounting flange 24, and towards an exit opening 26 defined through the mounting flange 24 and which is in communication with the cavity 16. It can be appreciated that the liquid in the container 12 would flow towards the exit opening 26 due to gravity and the sloping nature of the angled bottom wall 22.

The mounting flange 24 can include a flat planar surface capable for mounting with a flat planar surface of the back pump unit 30. Fasteners and/or an adhesive can be utilized to secure the back pump unit 30 to the mounting flange 24. It can be appreciated that the mounting flange 24 and the back pump unit 30 can be integrally formed to create a mounting flange and back pump unit combination.

One or more level sensors (not shown) can be utilized with any part of the container 12 to determine the amount of liquid in the container body 14. Further, a lid or cover (not shown) can be utilized with covering the open end of the container body 14.

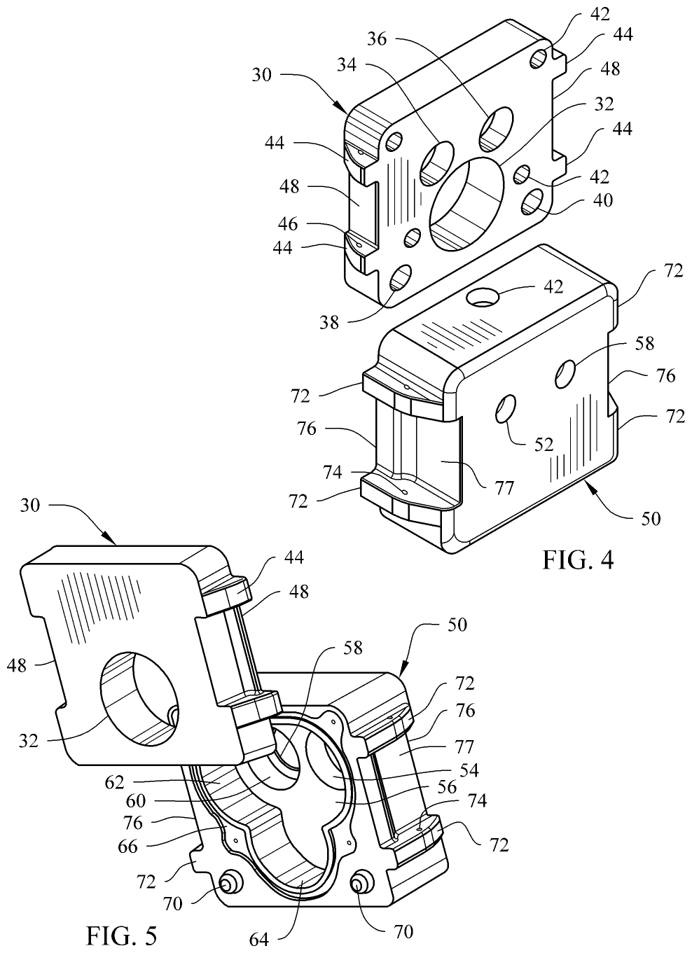

Referring to FIGS. 4 and 5, the back pump unit 30 can be attachable or integrally formed with the mounting flange 24. The back pump unit 30 can be made of, but not limited to, plastic, metals, alloys, composites, and the like. A flow bore 32 can be defined through the back pump unit 30 and aligned with the exit opening 26 of the mounting flange 24 when the back pump unit 30 is fitted to with the mounting flange 24. Accordingly, the flow bore 32 can be in communication with the exit opening 26 and consequently the cavity 16.

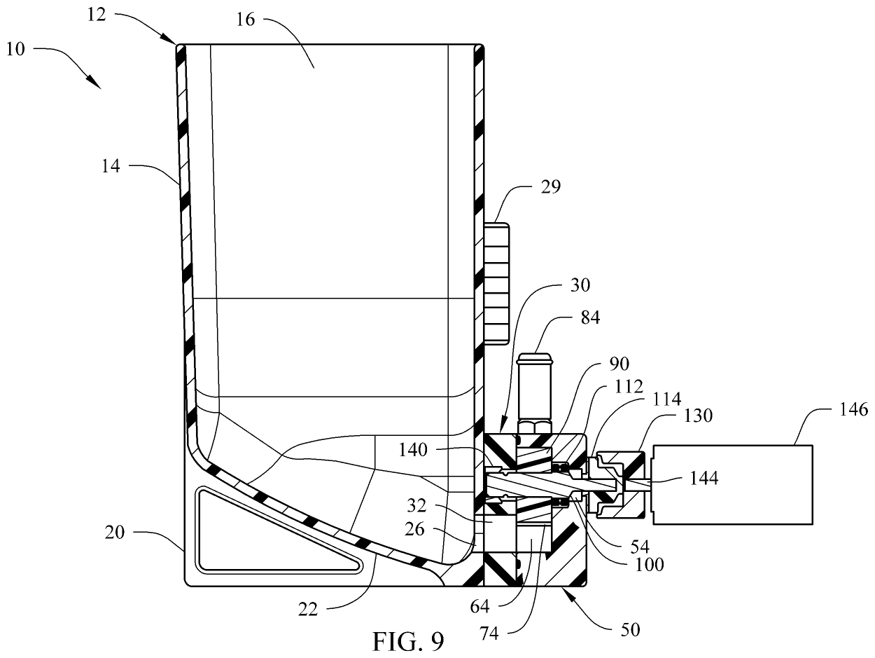

A first shaft bore 34 and a second shaft bore 36 can be defined in or through the back pump unit 30 in a spaced apart relationship with each other and with the flow bore 32. The first and second shaft bores 34, 36 are configured to receive a bushing or bearing 140 (see FIG. 9), respectively, that rotatable supports a bearing end 102 of a pump shaft 100 (see FIG. 7).

One or more guide holes 38, 40 can be defined in or through the back pump unit 30 in a spaced apart relationship with each other, with the first and second shaft bores 34, 36 and with the flow bore 32. The guide holes 38, 40 can be configured to receive guide posts 70 extending from a mounting side of the pump unit 50. The guide holes 38, 40 allow for proper positioning of the pump unit 50 with the back pump unit 30.

Extending from opposite sides of the back pump unit 30 can be a pair of spaced apart latch support members 44 defining a latching gap 48 therebetween. A pin bore 46 can be defined in or through each of the latch support members 44 so as to receive a latch pin configured to pivotably support a latch 150 in the latching gap 48.

One or more mounting holes 42 can be utilized with fasteners used to secure the back pump unit 30 to the mounting flange 24.

The pump unit 50 is removably attachable with the back pump unit 30, and is configured to pump the liquid from the container 12 through the exit opening 26 and the flow bore 32. The pump unit 50 can be made of, but not limited to, plastic, metals, alloys, composites, and the like. Further, the pump unit 50 can be, but not limited to, a lobe pump, a gear pump, a reciprocal pump, a centrifugal pump, a piston pump, a diaphragm pump, and the like. In the exemplary, the pump unit 50 of the present technology can be a lobe or gear pump.

A first shaft bore 52 and a second shaft bore 58 of the pump unit 50 can be defined in or through the pump unit 50 in a spaced apart relationship with each other and aligned with the first and second shaft bores 34, 36 of the back pump unit 30 with the pump unit 50 is fitted to the back pump unit 30. The first and second shaft bores 52, 58 of the pump unit 50 are configured to receive therethrough a second end 110 of the pump shaft 100 (see FIG. 7), respectively.

The pump unit 50 can include a hollow interior divided into multiple chambers. These chambers can include a first lobe pump chamber 56, a second lobe pump chamber 62 and a pumping chamber 64, all three of which are in communication with each other and extending into the pump unit 50 on a same side thereof.

The first lobe pump chamber 56 can include a first bushing, bearing or sealing gasket cavity 54 in communication with the first shaft bore 52. A first lobe pump chamber sidewall that defines at least a portion of the first lobe pump chamber 56 can be configured as a radius from a central longitudinal axis of the first shaft bore 52. A first lobe pump 90 can be configured to be rotatably received in the first lobe pump chamber 56.

The second lobe pump chamber 62 can include a second bushing, bearing or sealing gasket cavity 60 in communication with the second shaft bore 58. A second lobe pump chamber sidewall that defines at least a portion of the second lobe pump chamber 62 can be configured as a radius from a central longitudinal axis of the second shaft bore 58. A second lobe pump 90 can be configured to be rotatably received in the second lobe pump chamber 62 while engageable with the first lobe pump 90.

The pumping chamber 64 can be at least partially defined by a pump chamber sidewall that transitions from an end of the first lobe pump chamber sidewall of the first lobe pump chamber 56 and an end of the second lobe pump chamber sidewall of the second lobe pump chamber 62. Other ends of the first and second lobe pump chamber sidewalls, opposite to that transitioning to the pump chamber sidewall, can be connected by a planar sidewall thereby connecting the first and second lobe pump chamber sidewalls to each other. In the exemplary, the pumping chamber 64 can be located below or upstream of the first and second lobe pump chambers 56, 62.

Accordingly, the first and second lobe pump chamber sidewalls, the planar sidewall and the pump chamber sidewall can be characterized as a continuous sidewall that defines the first lobe pump chamber 56, the second lobe pump chamber 62 and the pumping chamber 64.

A recessed section 66 that surrounds the first lobe pump chamber 56, the second lobe pump chamber 62 and the pumping chamber 64 can extended into the pump unit 50 from a planar mounting side that abuts the back pump unit 30 when assembled.

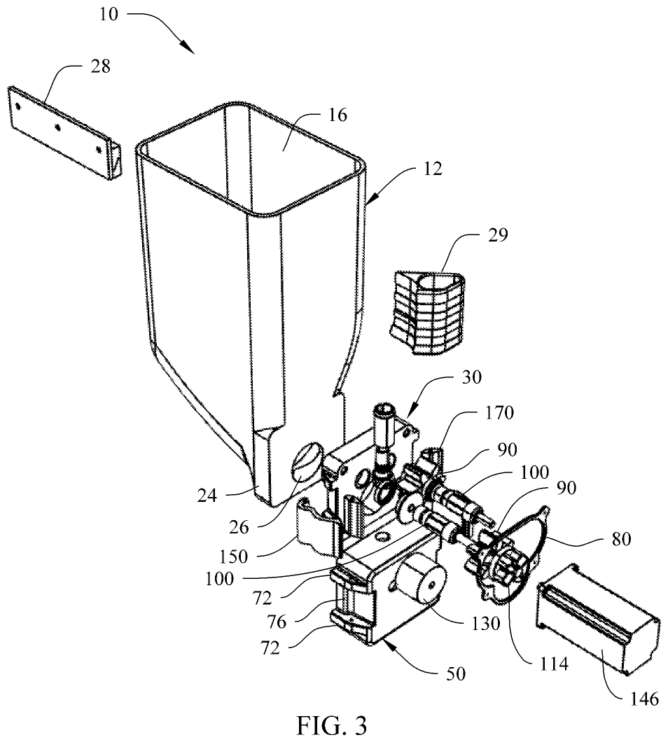

As best illustrated in FIGS. 3 and 8, a gasket or seal 80 is receivable in the recessed section 66 for providing a liquid-tight seal against the back pump unit 30 and with the first lobe pump chamber 56, the second lobe pump chamber 62 and the pumping chamber 64. The seal 80 can be secured in the recessed section 66 by multiple screws 81 that utilized with enlarged mounting sections of the seal 80. It can be appreciated that the seal 80 can fill the entire recessed section 66 from a perimeter sidewall that defines the recessed section 66 to an edge that transitions to the first and second lobe pump chamber sidewalls, the planar sidewall and the pumping chamber sidewall.

A discharge port 78 can be defined through a top section of the pump unit 50 and the planar sidewall that transitions between the first and second lobe pump chamber sidewalls. The discharge port 78 is in communication with the first and second lobe pump chambers 56, 62. As best illustrated in FIG. 7, a discharge fitting 82 can be fitted to or with the discharge port 78, and a dispenser fitting 84 can be threadably secured to the discharge fitting 82 exterior of the pump unit 50. A dispensing tube (not shown) can then be attached to the dispenser fitting 84 allowing liquid that is pumped from the pump unit 50 to be utilized for its intended operation.

In the exemplary, the dispensing tube (not shown) can be orientated to discharge liquid sauce pumped from the pump unit 50 to a sauce dispensing location of the food preparation machine, such as over a pizza dough.

Extending from opposite sides of the pump unit 50 can be a pair of spaced apart lock support members 72 defining a locking gap 76 therebetween. A pin bore 74 can be defined in or through each of the lock support members 72 so as to receive a lock pin configured to pivotably support a lock member 170 in the locking gap 76.

A recessed portion 77 can be defined in the locking gap 76 that provides an open space with a depth greater than the locking gap 76. The recessed portion 77 is configured to allow full or partial pivoting movement of the lock member 170 during a locking and/or unlocking operation of the latch 150.

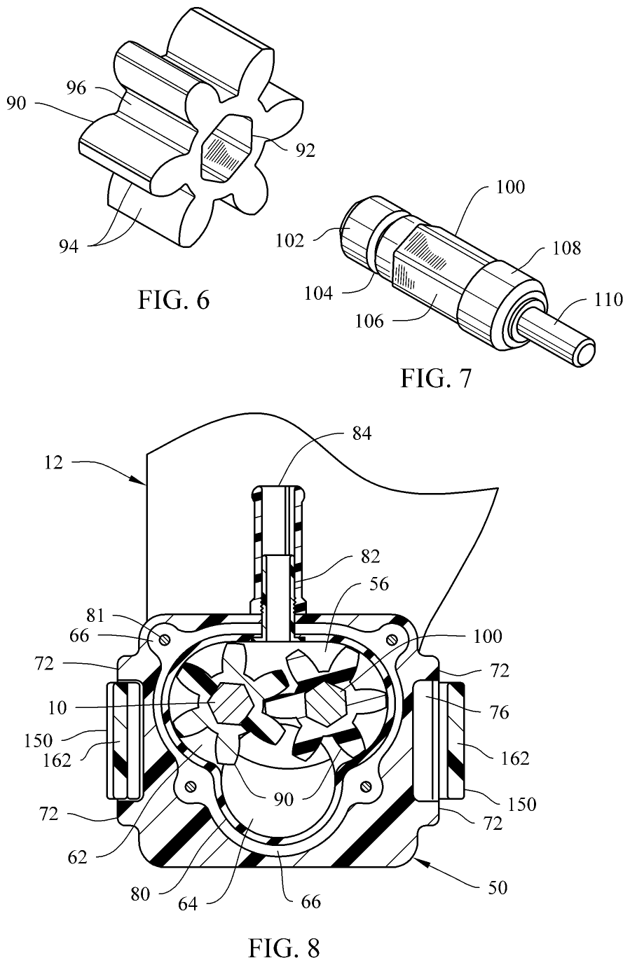

Referring to FIG. 6, lobe pumps use rotating lobed rotors 90, similar to gears, to create a consistent flow of fluids that moves liquids at a steady speed. Each lobed rotor 90 can include a geometrically profiled bore 92 centrally defined therethrough for engagement with the pump shaft 100. The present technology utilizes these lobe rotors 90 as a mechanism to create a suction or vacuum that draws in liquid and captures the fluid in its chamber 96 before passing it through to the discharge. In lobe pump, one of the rotors 90 can be driven by a motor 146 (see FIGS. 1-3, 9 and 10), which in turn can drive a second lobed rotor. Each rotor 90 of the present technology can have multiple lobes 94 that rotate and trap fluid therebetween, forcing fluid through the discharge port 78 on each rotation.

Referring to FIG. 7, the pump shaft 100 can include the bearing end 102, a lock or seal ring 104, a geometrically profiled mid-section 106, a second bearing section 108 and the second end 110.

The second bearing section 108 can have a width or diameter greater than a width of the profiled mid-section 106, thereby creating a stop ledge. The profiled mid-section 106 is configured to have a profile that corresponds with the geometrically profiled central bore 92 of at least one of the lobed rotors 90. It can be appreciated that the bearing end 102 can be inserted through the profiled central bore 92 of the lobe rotor 90 so that the geometric profiles of the central bore 92 and the mid-section 106 align. Consequently, the mid-section 106 can then be inserted into and through the central bore 92 until a side of the lobe rotor 90 contacts the stop ledge created by the second bearing section 108. The now engaged geometrically profiled central bore 92 and mid-section 106 transfers any rotation of the pump shaft 100 to the lobe rotor 90.

Referring to FIGS. 8-10, a first lobe rotor 90 can be rotatably received in the first lobe pump chamber 56, and a second lobe rotor 90 can be rotatably received in the second lobe pump chamber 62 so that the lobes 94 are engageable with the chambers 96 during rotation, as best illustrated in FIG. 8.

When the pump unit 50 is assembled with the back pump unit 30, the bearing end 102 of the pump shaft 100 extends into the first and second shaft bores 34, 36 of the back pump unit 30, respectively, so as to be engaged with their respective bearing 140 associated with the first and second shaft bores 34, 36.

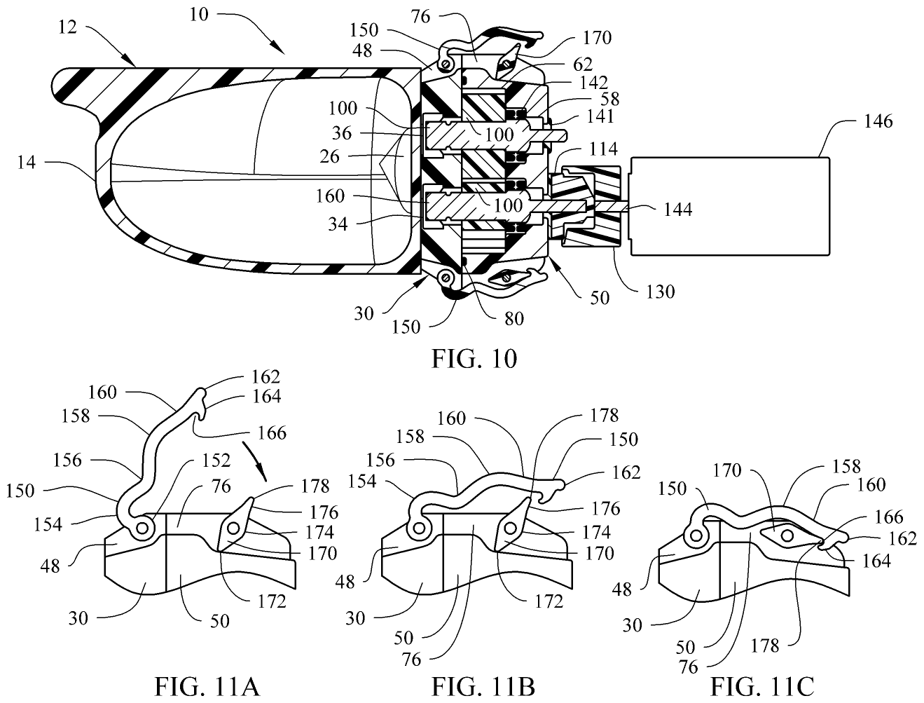

A shaft sealing gasket 112 can be received in the first and second gasket cavities 54, 60, as best illustrated in FIGS. 9 and 10. The sealing gasket 112 can be configured to provide a radial sealing force to the second bearing section 108 of the pump shaft.

A bushing or seal 141 can be inserted in each of the first and second shaft bores 52, 58, with the second end 110 of the pump shaft 100 extending out from the seal 141, respectively.

During operation, rotation of one of pump shafts 100 provides rotation of one of the lobe rotors 90, which in turn rotates the other lobe rotor 90 operably engaged therewith. This accordingly results in counter rotation lobe rotors 90 in the first and second lobe pump chambers 56, 62, as best illustrated in FIG. 8.

This counter rotation of the lobe rotors 90 can then pump any liquid in the pumping chamber 64 towards the discharge port 78, and thus out through the discharge fitting 82 and the dispenser fitting 84. The pumping action of the counter rotation lobe rotors 90 pulls in liquid from the pumping chamber 64 which receives the liquid from the flow bore 32 of the back pump unit 30, and which receives the liquid from the exit opening 26 of the mounting flange 24 of the container 12. The angled bottom wall 22 of the container 12 guides the liquid in the cavity 16 toward the exit opening 26, which can thus provide liquid into the pumping chamber 64.

It can be appreciated that the angled bottom wall 22 can provide a priming action for the lobe rotors 90 as liquid will always be directed toward the pumping chamber 64. This priming action can be accomplished as long as a height of the liquid in the container 12 is above the pumping chamber 64.

Referring to FIGS. 11A-11C, the latches 150 can be operated to allow quick assembly and/or disassembly of the pump unit 50 with the back pump unit 30 between an unlocked position (see FIG. 11A) and a locked position (see FIG. 11C).

Latches 150 can be pivotably received in its corresponding latching gap 48 of the back pump unit 30, respectively. Each latch 150 can include a pivoting end 152 that is configured to receive latch pin associated with the pin bores 46 of the latch support members 44. The latch pin allows for the latch 150 to pivot between the unlocked and locked positions.

Transitioning from the pivoting end 152 can be a first outwardly arched section 154, with a first inwardly arched section 156 transition from the first outwardly arched section 154, with a second outwardly arched section 158 transitioning from the first inwardly arched section 156, and with a second inwardly arched section 160 transition from the second outwardly arched section 158. It might be appreciated that the first and second inwardly arched sections 154, 158 can have a concave profile with respect to the pivoting end 152. It might be further appreciated that the first and second inwardly arched sections 156, 160 can have a convex profile with respect to the pivoting end 152. Accordingly, all the arched sections 154, 156, 158, 160 can provide an almost sinusoidal-like configuration.

A distal end 162 can transition from the second inwardly arched section 160, and can include a hook section 164 that is in a direction opposite to the distal end 162 or facing oppositely to the distal end 162. A lock notch 166 can be defined by the hook section 164 between an interior side of the second inwardly arched section 160 and the hook section 164. Accordingly, the lock notch 166 faces the pivoting end 152.

Lock members 170 can be pivotably received in its corresponding locking gap 76 of the pump unit 50, respectively. Each lock member 170 can include a retention end 172, a pivoting mid-section 174, a lock section 176, and a lock end 178. The pivoting mid-section 174 can be configured to receive the lock pin associated with the pin bores 74 of the lock support members 72. The lock pin allows for the lock member 170 to pivot between the unlocked and locked positions.

The lock section 176 can have a length from the pivoting mid-section 174 greater than a length of the retention end 172 from the pivoting mid-section 174. The length of the retention end 172 can be configured to prevent or stop pivotal movement of the lock member 170 past a predetermined angle, as best illustrated in FIGS. 11A and 11B. This length can provide a free end of the retention end 172 to pivot into the recessed section 77 of the locking gap 76 and contact a side or surface of the pump unit 50 that in part defines the recessed section 77. It can be appreciated that the length of the retention end 172 and/or the depth of the recessed section 77 can determine the stop position of the pivoting lock member 170.

Further, the retention end 172, a pivot point of the mid-section 174 and the lock end 178 can be aligned on the same axis with the pivot point of the mid-section 174 being between the retention end 172 and the lock end 178.

Prior to a locking operation, the pump unit 50 is fitted to the back pump unit 30 so that the guide posts 70 are received in the guide holes 38, 40 of the back pump unit 30. This positions the pump unit 50 so that the bearing ends 102 of the pump shafts 100 received through their corresponding first and second shaft bores 34, 36 and engaged with their corresponding bearings 140. This further positions the first and second lobe rotors 90 in their respective first and second lobe pump chambers 56, 62, while aligning the pumping chamber 64 with the flow bore 32.

After the pump unit 50 is fitted to the back pump unit 30, a locking operation can be performed. In an exemplary use, the latches 150 can each be pivoted about their pivoting end 152 so that the distal end 162 is directed towards the pump unit 50, as best illustrated in FIGS. 11A and 11B.

This pivoting motion moves the hook section 164 of the latch 150 towards the lock end 178 of the lock member 170 until the lock end 178 is received in the lock notch 166. The second outwardly arced section 160 of the latch 150 can be configured or can have a radius sufficient to allow the lock end 178 to pivot in and out of engagement with the lock notch 166 during a closing or locking motion of the latch 150.

Continued pivoting of the latch 150 results in pivoting of the lock member 170 into the locked position, as best illustrated in FIG. 11C. This further results in a stretching and/or bending of any one of or any combination of the arched sections 154, 156, 158, 160, thereby creating a biasing force on the hooked section 164 against the lock end 178 and the lock section 176.

In this locked position, the lock end 178 of the lock member 170 can be closer to the pump unit 50 than the retention end 172, thereby further directing the distal end 162 of the latch 150 towards locked position. This biasing force can be sufficient to keep the latch 150 in the locked position until the distal end 162 is pulled away from the lock member 170. This locking operation can be appreciated as a snaping operation with the hooked section 164 being snapped onto the lock end 178.

The biasing force created by the latch 150 against the lock member 170 is sufficient to pull the pump unit 50 against the back pump unit 30 so that the seal 80 prevents any liquid escaping from the first lobe pump chamber 56, the second lobe pump chamber 62 and the pumping chamber 64. The amount of the biasing force can be based on one of or combination of a distance of the lock notch 166 from the pivoting end 152 of the latch 150 and/or the length of the lock section 176 of the lock member 170. In the exemplary, a shorter distance of the lock notch 166 from the pivoting end 152 may create a greater biasing force as compared to a larger distance. Further in the exemplary, a shorter length of the lock section 176 may create a lesser biasing force as compared to a larger length.

To unlock the latch 150 from the lock member 170, the distal end 162 of the latch 150 can be pulled away from the pump unit 50, thereby acting against the biasing force and pivoting the lock member 170 away from the pump unit 50 and out of the locked position. Continued pulling of the latch 150 further pivots the lock member 170 so that the lock notch 166, which is engaged with lock end 178, is pulled away from lock end 178 and allowing the latch 150 to freely pivot out of the way to the unlocked position. This continued pulling of the lock member 170 away from the pump unit 50 rotates the lock member 170 about the pivot point of the mid-section 174 because of the engagement between the lock end 178 and the lock notch 166 of the hook section 164. The rotation of the lock member 170 consequently frees the latch 150 from the lock member 170, and places the latch in the unlocked position allow for removal of the pump unit 50.

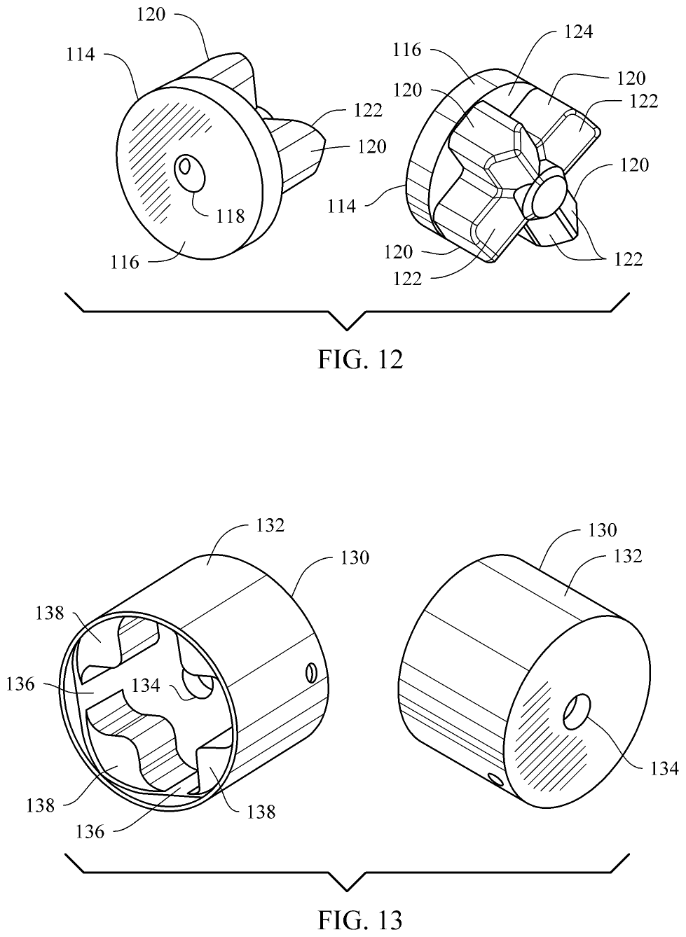

Referring to FIG. 12, a pump shaft cog 114 can be attached to the second end 110 of the pump shaft 100 exterior of the pump unit 50. The pump shaft cog 114 can include a planar side 116 featuring a shaft receiving bore 118 centrally defined therein. The planar side 116 is configured to face the pump unit 50 when the second end 110 is received and secured in the shaft receiving bore 118.

A plurality of cog teeth 120 can extend from the planar side 116 opposite the shaft receiving bore 118. Each cog tooth 120 can include a tapering or pointed end 122, and a teeth cavity 124 can be defined between each cog teeth 120. When assembled to the pump shaft 100, it can be appreciated that rotation of the pump shaft cog 114 results in rotation of the pump shaft 100 which consequently rotates one of the lobe rotors 90.

Referring to FIG. 13, the cog socket 130 can be attached to a motor shaft 144 (see FIGS. 9 and 10) that is operably associated with the motor 146. The cog socket 130 can have a cylindrical body 132 defining an internal socket cavity, a motor shaft receiving bore 134, and a plurality of socket teeth 138.

Each socket teeth 138 can extend inwardly from the cylindrical body 132 into the socket cavity. The socket teeth 138 can each have a configuration corresponding with the teeth cavity 124 of the pump shaft cog 114. A smooth or planar section 136 can be defined between each socket teeth 138 that can be configured to match a radially exterior side of each of the cog teeth 120.

It can be appreciated that a lateral profile of the cog teeth 120 and teeth cavity 124 of the pump shaft cog 114 is receivable in a lateral profile of the cog socket. This allows for the mating of the cog socket 130 with the pump shaft cog 114 for transferring rotation drive of the motor shaft 144 to one of the lobe rotors 90.

In use, it can now be understood that the pump unit 50 can be easily mounted to or dismounted from the back pump unit 30 allowing for quick and efficient cleaning of any and all components associated with the container 12, the back pump unit 30 and/or the pump unit 50. In the exemplary, this can be accomplished by removing the cog socket 130 and the motor 146 from engagement with the pump shaft cog 114.

After which, each of the latches 150 can be moved to their unlocked positions by pivoting away the latches 150 from their corresponding lock members 170. This then allows the pump unit 50 to be separated and removed from the back pump unit 30.

The container 12 and the back pump unit 30 can then be washed and cleaned by hand or can be placed in a dishwashing machine. In the alternative, the back pump unit 30 can be removed from the container 12 so that the bearings 140 can be removed from their respective shaft bores 34, 36 prior to cleaning and/or for replacement. Further, the removal of the back pump unit 30 from the mounting flange 24 can allow for the separate cleaning of the back pump unit 30.

With the pump unit 50 removed from the back pump unit 30 and the pump shaft cog 114 removed from its corresponding pump shaft second end 110, each of the assembled lobe rotors 90 and pump shafts 100 can be pulled out from their respective pump chambers 56, 62. After which, each of the shaft sealing gaskets 112 can be removed from their corresponding gasket cavities 54, 60.

Thereafter, the pump unit 50, the lobe rotors 90 and/or the pump shafts 100 can be cleaned or replaced.

After cleaning, all the components can be reassembled in reverse order as to the above disassembly operation, thereby allowing the pump system 10 to be reinstalled and used.

According to one aspect, the present technology can include a pump system 10 including a back pump unit 30, a pump unit 50, a latch 150 and a lock member 170. The back pump unit 30 can be associated with a container 12. The back pump unit 30 can define a flow bore 32 therethrough that is in communication with an interior cavity 16 of the container 12. The pump unit 50 can be configured to be removably mountable with the back pump unit 30. The pump unit 50 can include a pumping chamber 64 defined in the pump unit 50 that can be in communication with the flow bore 32 of the back pump unit 30 when the pump unit 50 is mounted to with the back pump unit 30. The latch 150 can be pivotably associated with the back pump unit 30. The lock member 170 can be pivotably associated with the pump unit 50. The latch 150 can be pivotable to a locked position configured to secure the pump unit 50 to the back pump unit 30, and an unlocked position configured to allow the pump unit 50 to be removed from the back pump unit 30. The latch 150 can include a latch end portion 162, 164, 166 that can be configured to engage with a lock end 178 portion of the lock member 170 in the locked position.

According to another aspect, the present technology can include a pump system 10 for a food preparation machine. The pump system 10 can include a container 12, a back pump unit 30, a pump unit 50, a latch 150 and a lock member 170. The container 12 can include a container body 14 defining an open end and an interior cavity 16 configured to receive a liquid usable with the food preparation machine. The container 12 can be configured to be mountable with the food preparation machine. The back pump unit 30 can be associated with the container 12. The back pump unit 30 can define a flow bore 32 therethrough that is in communication with the interior cavity 16 of the container 12. The pump unit 50 can be configured to be removably mountable with the back pump unit 30. The pump unit 50 can include a pumping chamber 64 defined in the pump unit 50 that can be in communication with the flow bore 32 of the back pump unit 30 when the pump unit 50 is mounted to with the back pump unit 30. The latch 150 can be pivotably associated with the back pump unit 30. The lock member 170 can be pivotably associated with the pump unit 50. The latch 150 can be pivotable to a locked position configured to secure the pump unit 50 to the back pump unit 30, and an unlocked position configured to allow the pump unit 50 to be removed from the back pump unit 30. The latch 150 can include a latch end portion 162, 164, 166 that can be configured to engage with a lock end portion 178 of the lock member 170 in the locked position.

According to yet another aspect, the present technology can include a pump system 10. That can be associated with a food preparation machine. The pump system 10 can include a container 12, a back pump unit 30, a pump unit 50, a latch 150 and a lock member 170. The container 12 can include a container body 14 defining an open end and an interior cavity 16 configured to receive a liquid usable with the food preparation machine. A mounting bracket 28 can be configured to removably mount the container 12 to a frame structure of the food preparation machine. The back pump unit 30 can be associated with the container 12. The back pump unit 30 can define a flow bore 32 therethrough that is in communication with the interior cavity 16 of the container 12. The pump unit 50 can be configured to be removably mountable with the back pump unit 30. The pump unit 50 can include a pumping chamber 64 defined in the pump unit 50 that can be in communication with the flow bore 32 of the back pump unit 30 when the pump unit 50 is mounted to with the back pump unit 30. The latch 150 can be pivotably associated with the back pump unit 30. The lock member 170 can be pivotably associated with the pump unit 50. The latch 150 can be pivotable to a locked position configured to secure the pump unit 50 to the back pump unit 30, and an unlocked position configured to allow the pump unit 50 to be removed from the back pump unit 30. The latch 150 can include a latch end portion 162, 164, 166 that can be configured to engage with a lock end 178 portion of the lock member 170 in the locked position. One of or any combination of the latch 150 and the lock member 170 can be configured to provide a biasing force in the locked position that is configured to act on the lock member 170 to pull the pump unit 50 toward the back pump unit 30.

According to still another one aspect, the present technology can include a method of removing a demountable pump system 10 from a container 12. The method can include the steps of providing a back pump unit 30 associated with the container 12, a pump unit 50 mountable to the back pump unit 30, a latch 150 pivotably associated with the back pump unit 30, and a lock member 170 pivotably associated with the pump unit 50. The back pump unit 30 can define a flow bore 32 therethrough that is in communication with an interior cavity 16 of the container 12. The pump unit 50 can include a pumping chamber 64 defined in the pump unit 50 that can be in communication with the flow bore 32 of the back pump unit 30 when the pump unit 50 is mounted to with the back pump unit 30. Pivoting the latch 50 from a locked position with the lock member 170 to an unlocked position, with the locked position securing the pump unit 50 to the back pump unit 30, and the unlocked position allows the pump unit 50 to be removed from the back pump unit 30. Rotating of the lock member 170 by the pivoting of the latch 150 so that a latch end portion 162, 164, 166 of the latch 150 moves a lock end portion 178 of the lock member 180. Releasing the latch end portion 162, 164, 166 of the latch 150 form the lock end portion 178 of the looking member 170 upon further pivoting of the latch 150 away from the lock member 170.

In some or all embodiments, the back pump unit 30 can include a pair of spaced apart latch support members 44 defining a latching gap 48 therebetween with the latch 150 being pivotably received in the latching gap 48. The latch 150 further being pivotably engaged with each of the latch support members 44.

In some or all embodiments, the pump unit 50 can include a pair of spaced apart lock support members 72 defining a locking gap 76 therebetween with the lock member 170 being pivotably received in the locking gap 76. The lock member 170 being pivotably engaged with each of the lock support members 72.

In some or all embodiments, the latch end portion of the latch 150 can include a hook section 164 defining a lock notch 166.

In some or all embodiments, the lock end portion 176 of the lock member 170 can include a lock end 178 configured to be received in the lock notch 166 when the latch 150 and the lock member 170 are in the locked position.

In some or all embodiments, the latch 150 can include one or more arched sections 154, 156, 158, 160 that can be configured to provide a biasing force that pulls the hook section 164 of the latch 150 toward the lock end 178 of the lock member 170 when in the locked position.

In some or all embodiments, the latch 150 can have a length configured to act against the lock member 170 when in the locked position to secure the pump unit 50 against the back pump unit 30.

In some or all embodiments, the lock member 170 can have a length configured so that a hook section 164 of the latch 150 acts against a lock end 178 of the lock member 170 when in the locked position to secure the pump unit 50 against the back pump unit 30.

In some or all embodiments, the lock member 170 can include a retention end 172 opposite to the lock end 178. The retention end 172 can be configured to contact a side of the pump unit 50 to prevent the lock end 178 from pivoting past a predetermined distance away from the pump unit 50 in the unlocked position.

In some or all embodiments, the pump unit 50 can include at least two counter rotating lobe rotors 90 configured to pump a liquid from the pumping chamber 64 to a discharge port 78 of the pump unit 50.

In some or all embodiments, at least one of the lobe rotors 90 can be engaged with a pump shaft 100 that can be configured to engage with a cog 114 located exterior of the pump unit 50.

Some or all embodiments of the present technology can include a cog socket 130 operably engaged with a motor 146. The cog socket 130 can be configured to engageably receive the cog 114 to drive the cog 114 upon operation by the motor 146.

In some or all embodiments, the container 12 can include an angled bottom wall 22 that is sloped toward the flow bore 32 of the back pump unit 30.

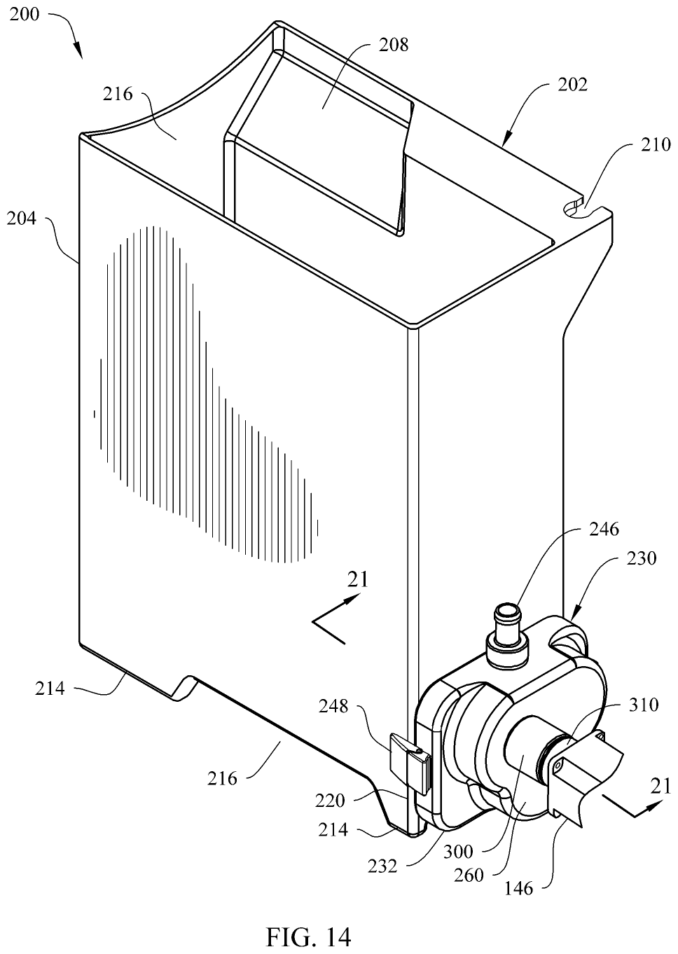

Referring now to FIGS. 14-23, according to another embodiment, a new and novel dismountable pump system 200 can be utilized for removably mounting a pump housing or pump unit 230 to a discharge section 220 of a container 202. The pump unit 230 can include a pumping chamber 254 defined therein. When the pump unit 230 is mounted to the discharge section 220 of the container 202, the pumping chamber 254 is in fluid communication with the discharge section 220 of the container 202 and the pump unit 230 is secured to the discharge section 220 by a fastener 248 in a locked position. When the pump unit 230 is removed from the discharge section 220 of the container 202, the fastener 248 is in an unlocked position.

The fastener 248 can be one or more fasteners capable of securing the pump unit 230 to the discharge section 220 in the locked position and capable of allowing the pump unit 230 to be removed from the discharge section 220 in the unlocked position. It can be appreciated that the fasteners 248 or any part thereof can be associated with any one of, any part of or any combination of the container 202, the discharge section 220 and the pump unit 230. The fasteners 248 can be, but not limited to, latches, hooks, bolts, screws, straps, bands, ties, magnets, levers, snaps, pins, and any mechanism capable of securing the pump unit 230 to the container 202. In the exemplary, the drawings illustrates and the following description makes reference to latches 248. Further, the fastener 248 can be any mechanism that pulls the pump unit 230 toward the discharge section 220.

It can be appreciated that the pump system 200 omits the back pump housing from the above described pump assembly of FIGS. 1-13 and configures the discharge section 220 of the container 202 to serve as a second half or as a back pump housing to the pump unit 230.

According to one embodiment, the pump system 200 reduces manufacturing costs while allowing for the pump unit 230 to be more easily mounted to and dismounted from the container 202.

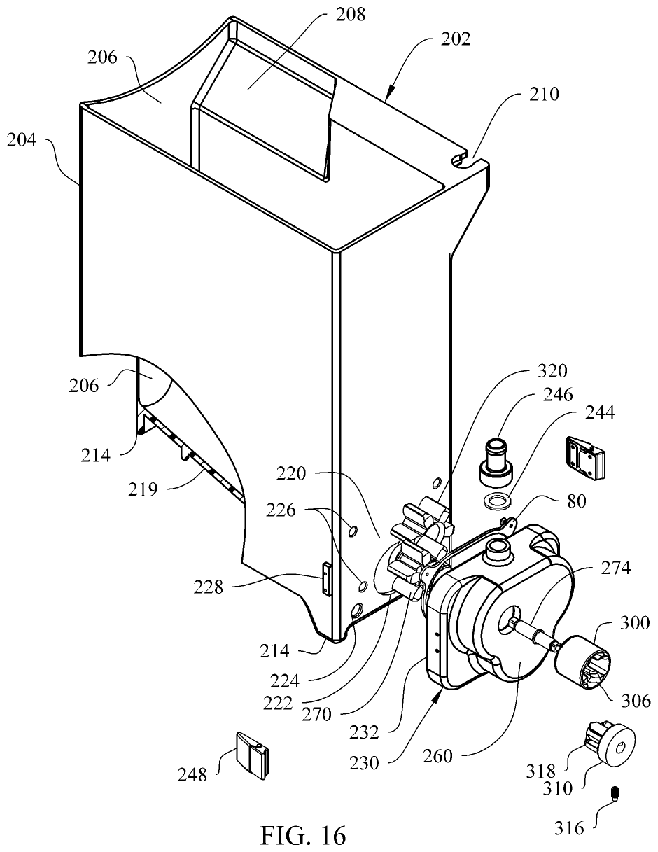

The container 202, as best illustrated in FIGS. 14-16, can include a container body 204 featuring sidewalls defining an open top end and an interior cavity 206, an angled top section 208, a supply hose retaining notch 210, a base section including feet 214 for supporting the container in an upright position, reinforcing ribs 218, and a sloped or angled bottom wall 219 as best illustrated in FIG. 16. The container 202 can be made of, but not limited to, plastic, metals, alloys, composites, and the like. A liquid or semiliquid such as, but not limited, sauces, creams, marinates, pastes, and the like, can be stored in the interior cavity 206 for use with the pump unit 230 so as to be pumped from a bottom section of the container 202 for use with other components.

The feet 214 can be configured to allow the container 202 to be supported vertically on a surface or in a machine. According to one embodiment, this allows for work to be performed on the pump system 200 more easily. It can be appreciated that the container 202 can include mounting brackets or members to secure the container 202 to a surface or machine.

Hand gripping sections 216 and/or 212 can be configured to be grasped by a user for manipulation of the pump system 200 and/or the container 202. The hand gripping sections 216 can be an opening defined between feet 214 allowing fingers or a hand of the user to grasp the container 202.

The discharge section 220 is formed on one sidewall of the container 202, which can be a flat or planar surface. The sidewall forming the discharge section 220 can be vertically, substantially vertically or perpendicularly oriented to a bottom side, bottom wall or base of the container 202. It can be appreciated that the latches 248 can be associated and/or engageable with latch hooks or latch receiving surfaces 228. The latches 248 and/or the latch receiving surfaces 228 can be associated with sides of the container 202 adjacent to the discharge section 220 for securing the pump unit 230 to the discharge section 220. It can be appreciated that the latches 248 can be associated with the pump unit 230, with the latch receiving surfaces 228 being associated with the container 202, or vice versa.

One or more level or other sensors (not shown) can be utilized with any part of the container 202 to determine the amount or characteristic of liquid in the container body 204. Further, a lid or cover (not shown) can be utilized with covering the open end of the container body 204.

As best illustrated in FIG. 16, the discharge section 220 can include a flow bore 222 defined therethrough, one or more guide holes 224, and/or one or more screw head receiving recesses 226. Furthermore, a plug or cap (not shown) can be utilized with the flow bore 222 to contain the liquid in the container 202 when the pump unit 230 is not mounted to the discharge section 220.

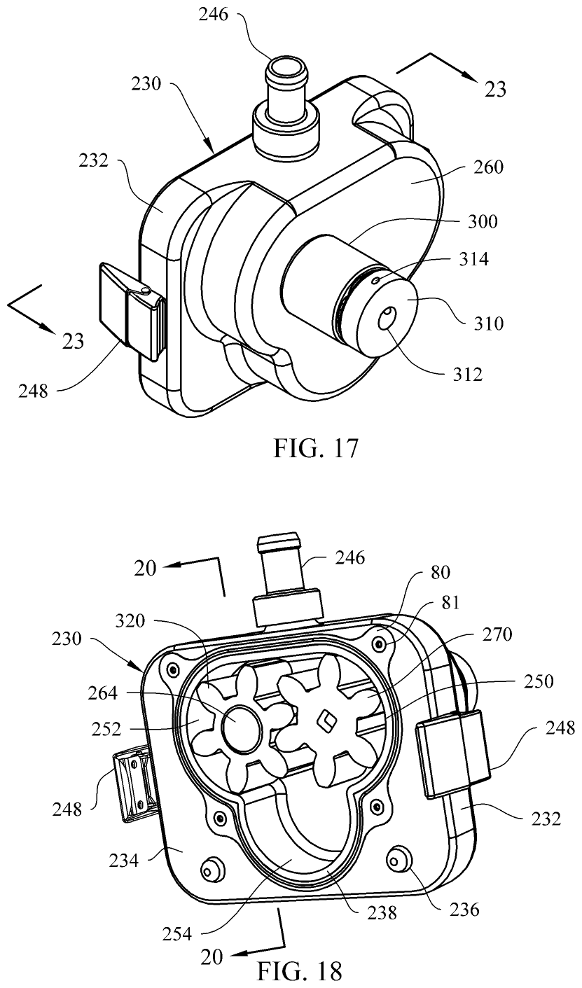

With reference to FIGS. 17-23, it can be appreciated that the pump unit 230 contains all pump mechanisms, while the latches 248 secure the pump unit 230 to the discharge section 220, thereby allowing the pump unit 230 to be removed from the container 202.

The pump unit 230 can include a back pump section 232 configured to mate or mount with the discharge section 220, and a front pump section 260 extending from the back pump section 232 in a direction away from the discharge section 220 when the pump unit 230 is mounted thereto.

The back pump section 232 includes a flat or planar mounting surface or mounting side 234 that corresponds with the flat or planar surface of the discharge section 220, thereby creating sealable mating surfaces when abutted. When mounted to the discharge section 220, the pump unit 230 can be located on the sidewall of the container 202 that is substantially perpendicular to a plane of a surface that supports the container 202 when the container is located on the surface. In the exemplary orientation, if the container 202 is placed on a substantially horizontal surface, the discharge section 220 would be vertically oriented with a longitudinal axis of the flow bore being parallel with the surface and/or perpendicular with a vertical plane defining the discharge section 220. Accordingly, when the pump unit 230 is mounted to the discharge section 220, the fluid or liquid travels in a horizontal direction when entering the pumping chamber 254, and then transfers to a vertical direction by the first and second rotors 270, 320.

A recessed section 238 is defined in the mounting side 234 that surrounds a first rotor chamber 250, a second rotor chamber 252 and the pumping chamber 254. The first rotor chamber 250, the second rotor chamber 252 and the pumping chamber 254 are all in fluid communication with each other and can extend into the pump unit 230 from the mounting side 234. Accordingly, the first rotor chamber 250, the second rotor chamber 252 and the pumping chamber 254, being defined in the pump unit 230, are open to the outside from the mounting side 234, as best illustrated in FIG. 18.

The first rotor chamber 250 can be configured to rotatably receive a first lobed rotor 270, and the second rotor chamber can be configured to rotatably receive a second lobed rotor 320. The pumping chamber 254 is substantially aligned with the flow bore 222 of the discharge section 220 when the pump unit 230 is mounted to the discharge section 220.

As best illustrated in FIGS. 16, 18-21 and 23, the gasket or seal 80 is receivable in the recessed section 238 for providing a liquid-tight seal between the discharge section 220 and the back pump section 232 when the latches 248 are in the locked position. The seal 80 can be in juxtaposition with and surrounding the first rotor chamber 250, the second rotor chamber 252 and the pumping chamber 254. The seal 80 can be secured in the recessed section 238 by screws 81 that are utilized with enlarged or flanged mounting sections of the seal 80. When the pump unit 230 is mounted to the discharge section 220, the heads of the screws 81 can be received in the screw head receiving recesses 226, thereby created a continuous contact between the seal 80 and the surface of the discharge section 220. It can be appreciated that the seal 80 can fill a portion of the recessed section 238 or the entire recessed section 238 from a perimeter sidewall that defines the recessed section 238 to an edge that transitions to sidewalls that define the first rotor chamber, the second rotor chamber and the pumping chamber.

It can be appreciated that the recessed section 238 can be defined in the discharge section 220 and configured to receive the seal 80 to form a sealing contact with a perimeter profile that surrounds the first rotor chamber 250, the second rotor chamber 252 and the pumping chamber 254.

It can be further appreciated that the seal 80 may be utilized without the recessed section 238 and manually positioned between the discharge section 220 and the mounting side 234.

The latches 248 and/or the latch receiving surfaces 228 can be associated with sides of the pump unit 230 adjacent to a mounting surface or side 234 for securing the pump unit 230 to the discharge section 220. The latches 248 can include a single or multiple pivoting mechanism that engages with the latch receiving surfaces 228, thereby allowing for the pump unit 230 to be pulled toward the discharge section 220 and locked in place. This pulling action by the latches 248 can further ensure a tight seal between the seal 80 and the surface of the discharge section 220. It can be appreciated that this pulling action can be accomplished by, but not limited to, a threaded bolt or screw, or a threaded shaft and nut arrangement.

One or more guides 236 can extend out from the mounting side 234, and can be receivable in the guide holes 224 defined in the discharge section 220. The guides 236 and the guide holes 224 allow for proper positioning of the pump unit 230 with the discharge section 220 and/or for proper alignment of the pumping chamber 254 and the flow bore 222.

A discharge nozzle 242 can extend from a side of the back pump section 232 and/or the front pump section 260 so that a discharge port defined in the discharge nozzle 242 is in fluid communication with the first and second rotor chambers 250, 252. As best illustrated in FIGS. 16, 19 and 23, a discharge fitting 246 can be attached to the discharge nozzle 242, and a washer 244 can provide a sealed connection therebetween. The discharge fitting 246 can be threadably secured to the discharge nozzle 242 exterior of the pump unit 230, allowing for a controllable compression with the washer 244. A dispensing tube (not shown) can then be attached to the discharge fitting 246 allowing liquid that is pumped from the pump unit 230 to be utilized for its intended operation.

It can be appreciated that the discharge nozzle 242 and the discharge fitting 246 can be a single integral unit formed with or attached to the pump unit 230.

When the latches 248 are in the locked position, thereby mounting and sealing the pump unit 230 to the discharge section 220, a complete pump chamber is created between the discharge section 220 and mounting side 234 that includes the first rotor chamber 250, the second rotor chamber 252 and the pumping chamber 254.

It can be appreciated that the fluid or liquid in the interior cavity 206 of the container 202 is directed toward the flow bore 222 in part by the shape of the sidewalls that defines the container 202 and the angled bottom wall 219. The fluid or liquid can then travel through the flow bore 222 and into the pumping chamber 254, which can both be substantially parallel with the plane of the surface supporting the container 202 or perpendicular to a plane defining the discharge section 220. The fluid or liquid can then be pumped from the pumping chamber 254, in a direction perpendicular to that of entry into the pumping chamber 254, by rotation of the first and second rotors 270, 320 into the discharge port defined in the discharge nozzle 242. The discharge port or the discharge nozzle 242 can be parallel with the plane that defines the discharge section 220.

In this configuration, the fluid or liquid can enter the pumping chamber 254 in a plane that is perpendicular to a pumping direction of the fluid or liquid provided by the first and second rotors 270, 320. Accordingly, when assembled, the first and second rotors 270, 320 rotate about an axis that is parallel with a plane that defines the flow bore 222 and the pumping chamber 254, and/or perpendicular to the plane that defines the discharge section 220.

The front pump section 260 can have sidewalls that extend from the back pump section 232 in a configuration corresponding to the first rotor chamber 250, the second rotor chamber 252 and the pumping chamber 254. It can be appreciated that the front pump section 260 can have any configuration that can effectively define the first rotor chamber 250, the second rotor chamber 252 and the pumping chamber 254. It can further be appreciated that the back pump section 232 and the front pump section 260 can be an integral body.

The front pump section 260 can include a shaft bore 262 defined therethrough that is in communication with the first rotor chamber 250, as best illustrated in FIGS. 16, 19 and 21.

The front pump section 260 can further include a shaft 264 extending into the second rotor chamber 252 and configured to rotatably locate the second rotor 320 in the second rotor chamber 252. The second rotor 320 can have a shaft bore 322 configured to receive the shaft 264, thereby providing free rotation of the second rotor 320. The shaft 264 can allow for the second rotor 320 to be driven by the first rotor 270 engaged therewith. It can be appreciated that a bearing or bushing (not shown) can be utilized in the shaft bore 322 and with the shaft 264.

As best illustrated in FIGS. 21-23, a drive shaft assembly 273 can be utilized to transfer rotation from the motor 146 to the first rotor 270 located inside the pump unit 230. The drive shaft assembly 273 can include a drive shaft 274 can be configured to pass through the shaft bore 262 so that a first end 276 is received and engaged with at least a portion of a drive shaft bore 272 defined through the first rotor 270 while the first rotor is located in the first rotor chamber 250. According to one embodiment, the first end 276 and the drive shaft bore 272 have corresponding geometrical profiles that allows for a transfer of rotation from the drive shaft 274 to the first rotor 270. It can be appreciated that the first end 276 can be secured to the first rotor 270 by a set screw (not shown) or any other engagement means that allows for the transfer of rotation from the drive shaft 274.

The drive shaft 274 can further include a stop ledge 278 extending therefrom, a second end 280 and a threaded post 282 extending out from the second end 280.

A first rotary seal 286 can be fitted over the first end 276 and on to the drive shaft 274 adjacent or abutting the stop ledge 278.

A bearing 284 can be fitted over the second end 280 and on to the drive shaft 274 adjacent or abutting the stop ledge 278.

A shaft retaining ring 288 can be fitted over the second end 280 and on to the drive shaft 274 adjacent or abutting the bearing 284. A perimeter edge of the retaining ring 288 can be received in a slot 263 defined in the front pump section 260, the slot being in communication with the shaft bore 262, as best illustrated in FIG. 21.

A second rotary seal 290 can be fitted over the second end 280 and on to the drive shaft 274 adjacent or abutting the retaining ring 288.

The above configuration is in the exemplary, as the bearing 284 can be located between the first and second rotary seals 286, 290 with the stop ledge 278 located between the first rotary seal 286 and the bearing 284. Other configurations are possible, such as but not limited to, the stop ledge 278 located between the bearing 284 and the retaining ring 288.

It can be appreciated that the drive shaft 274 can be a shaft with a continuous diameter where stop blocks, rings or washers can be attached to the ends to locate and secure the first rotary seal 286, the bearing 284 and the second rotary seal 290.

With the above drive shaft assembly in mind, the first rotary seal 286, the bearing 284, the retaining ring 288 and the second rotary seal 290 can all be received, located and/or fitted in the shaft bore 262 while being operatively engaged with the drive shaft 274.

The second end 280 of the drive shaft 274 can be operatively driven by the motor 146 outside of the front pump section 260. The motor 146 can provide rotation to the drive shaft 274 that in turn rotates the first rotor 270 inside the first rotor chamber 250, which in turn counter rotates the second rotor 320 inside the second rotor chamber 252, thereby providing a pumping action to the liquid in the pumping chamber 254 provided from the interior cavity 206.

According to one embodiment, but not limited thereto, a cog socket 300 can be operatively engaged to the second end 280 of the drive shaft 274 outside the front pump section 260. The cog socket 300 can include a drive shaft bore 302 defined in a closed end of the cog socket 300, and a post bore 304 defined through the closed end and in communication with the drive shaft bore 302. According to one embodiment, the second end 280 and the drive shaft bore 302 can have corresponding and engageable geometrical profiles that allows for a transfer of rotation from the cog socket 300 to the drive shaft 274.

A threaded nut, endcap or member 292 can be engageable with the threaded post 282 extending out from the post bore 304 into an internal socket cavity of the cog socket 300. The member 292 can be utilized to secure the cog socket 300 to the drive shaft 274. The cog socket 300 can have a cylindrical body defining the internal socket cavity, and a plurality of socket teeth 306 extending inwardly from the cylindrical body into the socket cavity.

A cog 310 can be attached to the motor shaft 144 of the motor 146. The cog 310 can include a shaft receiving bore 312 centrally defined therein for receiving the motor shaft 144. A set screw 316 can be engageable with a set screw bore 314 to contact the motor shaft 144 thereby securing to the cog 310. A plurality of cog teeth 318 can extend from a planar side of the cog 310. Each cog tooth 318 is configured to be receivable in the internal cavity of the cog socket 300 and engageable with the socket teeth 306, thereby transferring rotational motion from the motor shaft 144 to the cog 310 and then to the cog socket 300.

It can be appreciated that the cog socket 300 can be attached to the motor shaft 144, and the cog 310 can be attached to the second end 280 of the drive shaft 274.

According to one embodiment, it can now be understood that the pump unit 230 can be easily mounted to or dismounted from the discharge section 220 of the container 202 allowing for quick and efficient cleaning of any and all components associated with the container 202, and/or the pump unit 230.

In the exemplary, this can be accomplished by disengaging the cog socket 300 and the cog 310 and removing the motor 146. After which, each of the latches 248 can be moved to their unlocked positions. This then allows the pump unit 230 to be separated and removed from the discharge section 220.

Once the pump unit 230 is removed from the discharge section 220, the second rotor 320 can be removed from its shaft bore 262. The cog socket 300 or cog 310 can be removed from the second end 280 of the drive shaft, allowing for removal of the second rotary seal 290 from the shaft bore 262.

This then allows access to and removal of the retaining ring 288 from the slot 263. After which, the drive shaft 274, the first rotary seal 286 and the bearing 284 can be removed from the shaft bore 262.

With the pump unit 230 removed from the discharge section 220, the container 202 and the pump unit 230 can then be cleaned by hand or can be placed in a dishwashing machine.

Thereafter, the pump unit 230, the first and second rotors 270, 320 and/or the drive shaft 274 can be cleaned, repaired and/or replaced.

After cleaning, all the components can be reassembled in reverse order as to the above disassembly operation, thereby allowing the pump system 200 to be reinstalled and used.

According to one embodiment, the pump system 200 can include the pump unit 230, and one or more fasteners 248. The pump unit 230 can be removably mountable to the discharge section 220 of the container 202. The pump unit 230 can include the pumping chamber 254 defined therein, with the pumping chamber 254 being in fluid communication with the flow bore 222 defined through the discharge section 220 when the pump unit 230 is mounted to the discharge section 220. The fasteners 248 secure the pump unit 230 to the discharge section 220 in a locked position and allows the pump unit 230 to be removed from the discharge section 220 in an unlocked position.

According to one embodiment, the pump unit 230 can include the back pump section 232 configured to mate with the discharge section 220, the front pump section 260 extending from the back pump section 232, the first rotor chamber 250, the second rotor chamber 252 and the pumping chamber 254 each defined in the pump unit 230. The first rotor chamber 250, the second rotor chamber 252 and the pumping chamber 254 can all be in fluid communication with each other. The pumping chamber 254 can be in fluid communication with the flow bore 222 defined through the discharge section 220 when the pump unit 230 is mounted to the discharge section 220. The first rotor 270 can be rotatably received in the first rotor chamber 250, and the second rotor 320 can be rotatably received in the second rotor chamber 252. The latches 248 secures the pump unit 230 to the discharge section 220 in the locked position and allows the pump unit 230 to be removed from the discharge section 220 in the unlocked position.

According to one embodiment, the pump system 200 can include the container 202, the pump unit 230, the drive shaft assembly and one or more latches 248. The container 202 can contain a pumpable material, and can include the angled bottom wall 219 that is sloped toward the flow bore 222 defined through the discharge section 220. The pump unit 230 can be removably mountable to the discharge section 220. The pump unit 230 can include the back pump section 232 mountable to the discharge section 220, the front pump section 260 extending from the back pump section 232, the first rotor chamber 250, the second rotor chamber 252 and the pumping chamber 254 each defined in the pump unit 230. The first rotor chamber 250, the second rotor chamber 252 and the pumping chamber 254 can all be in fluid communication with each other. The pumping chamber 254 can be in fluid communication with the flow bore 222 defined through the discharge section 220 when the pump unit 230 is mounted to the discharge section 220. The first rotor 270 can be rotatably received in the first rotor chamber 250. The second rotor 320 can be rotatably received in the second rotor chamber 252. The drive shaft assembly can include the drive shaft 274, the first rotary seal 286, the bearing 284 and the second rotary seal 290. The drive shaft 274 can be operatively driven by the motor 146, and can be configured to pass through the shaft bore 262 defined through the front pump section 260 and into the first rotor chamber 250. The first rotor 270 can be attachable to the first end 276 of the drive shaft 274. The first rotary seal 286 can be receivable in the shaft bore 262 and operatively engaged with the drive shaft 274. The bearing 284 can be receivable in the shaft bore 262 and operatively engaged with the drive shaft 274. The second rotary seal 290 can be receivable in the shaft bore 262 and operatively engaged with the drive shaft 274. The bearing 284 can be located between the first rotary seal 286 and the second rotary seal 290. The latches 248 secures the pump unit 230 to the discharge section 220 in the locked position and allows the pump unit 230 to be removed from the discharge section 220 in the unlocked position.

According to one embodiment, a method of removably mounting the pump unit 230 to the discharge section 220 of the container 202 by way of the fastener 248. The pump unit 230 can include the pumping chamber 254 defined therein. The method can include the steps of positioning the pump unit 230 against the discharge section 220 of the container 202 so that the pumping chamber 254 is in fluid communication with the flow bore 222 defined through the discharge section 220. Securing the pump unit 230 to the container 202 when the fastener 248 is in the locked position. Removing the pump unit 230 from the discharge section 220 of the container 202 when the fastener 248 is in the unlocked position.

In some or all embodiments, the pump unit 230 can include the back pump section 232 mountable to the discharge section 220.

In some or all embodiments, the pump unit can include the front pump section 260 extending from the back pump section 232.

Some or all embodiments can include the first rotor 270 rotatably located in the first rotor chamber 250, and the second rotor 320 rotatably located in the second rotor chamber 252. The first rotor chamber 250, the second rotor chamber 252 and the pumping chamber 254 can all be in fluid communication with each other.

Some or all embodiments can include the seal 80 in juxtaposition with the first rotor chamber 250, the second rotor chamber 252 and the pumping chamber 254. The seal 80 can form a sealed contact between the discharge section 220 and the back pump section 232 when the fastener 248 is in the locked position.

In some or all embodiments, the front pump section 260 can include the shaft 264 extending into the second rotor chamber 252. The shaft 264 can rotatably locate the second rotor 320 in the second rotor chamber 252.

In some or all embodiments, the first rotor 270 and the second rotor 320 can be counter rotating and configured to pump a liquid from the pumping chamber 254 to the discharge nozzle 242 of the pump housing or unit 230.

Some or all embodiments can include the drive shaft 274 configured to pass through the shaft bore 262 defined through the front pump section 260 and into the first rotor chamber 250. The first rotor 270 can be attachable to the first end 276 of the drive shaft 274 that is operatively driven by the motor 146.

Some or all embodiments can include the first rotary seal 286 located in the shaft bore 262 and operatively engaged with the drive shaft 274.

Some or all embodiments can include the bearing 284 located in the shaft bore 262 and operatively engaged with the drive shaft 274.

Some or all embodiments can include the second rotary seal 290 located in the shaft bore 262 and operatively engaged with the drive shaft 274.

In some or all embodiments, the bearing 284 can be located between the first rotary seal 286 and the second rotary seal 290.

In some or all embodiments, the drive shaft 274 can include the stop ledge 278 extending out therefrom and configured adjacent to the bearing 284.

Some or all embodiments can include the threaded member 292 configured to secure the cog 310 or the cog socket 300 to the second end 280 of the drive shaft 274. The cog or cog socket can be operatively engageable with the motor 146.

In some or all embodiments, the back pump section 232 can include the one or more guides 236 extending therefrom and receivable in the guide holes 224 defined in the discharge section 220.

In some or all embodiments, the container 202 can include the angled bottom wall 219 that is sloped toward the flow bore 222 of the discharge section 220.

In some or all embodiments, the container 202 can include feet 214 extending from a bottom side thereof for supporting the container 202, and the hand grips 216.

While embodiments of the pump system and method have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable sturdy material may be used instead of the above-described. And although pumping a fluid utilizing a dismountable pump housing assembly have been described, it should be appreciated that the pump system and method herein described is also suitable for providing a pump housing assembly that is easily disassembled for cleaning and reassembled for operation.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

What is claimed is:

1. A pump unit for removably mounting to a discharge section of a container, the pump unit comprising:
a pump housing including a pumping chamber defined therein; and
a fastener;
wherein, when the pump unit is mounted to the discharge section of the container, the pumping chamber is in fluid communication with the discharge section of the container and the pump unit is secured to the discharge section by the fastener in a locked position; and
wherein, when the pump unit is removed from the discharge section of the container, the fastener is in an unlocked position.

2. The pump unit according to claim 1, wherein the pump housing includes a back pump section mountable to the discharge section, and a front pump section extending from the back pump section.

3. The pump unit according to claim 2 further comprising a first rotor rotatably located in a first rotor chamber, and a second rotor rotatably located in a second rotor chamber, wherein the first rotor chamber, the second rotor chamber and the pumping chamber are all in fluid communication with each other.

4. The pump unit according to claim 3 further comprising a seal in juxtaposition with the first rotor chamber, the second rotor chamber and the pumping chamber, the seal forming a sealed contact between the discharge section and the back pump section when the fastener is in the locked position.

5. The pump unit according to claim 3, wherein the front pump section includes a shaft extending into the second rotor chamber, the shaft rotatably locates the second rotor in the second rotor chamber.

6. The pump unit according to claim 3 further comprising a drive shaft configured to pass through a shaft bore defined through the front pump section and into the first rotor chamber, wherein the first rotor is attachable to a first end of the drive shaft that is operatively driven by a motor.

7. The pump unit according to claim 6 further comprising a first rotary seal located in the shaft bore and operatively engaged with the drive shaft, a bearing located in the shaft bore and operatively engaged with the drive shaft, and a second rotary seal located in the shaft bore and operatively engaged with the drive shaft, wherein the bearing is located between the first rotary seal and the second rotary seal.

8. The pump unit according to claim 7, wherein the drive shaft includes a stop ledge extending out therefrom and configured adjacent the bearing, and wherein a threaded member is configured to secure a cog or a cog socket to a second end of the drive shaft, the cog or the cog socket being operatively engageable with the motor.

9. The pump unit according to claim 1, wherein the fastener is a latch.

10. The pump unit according to claim 9, wherein the latch is on a side of the pump unit adjacent to a mounting side of the pump unit, the mounting side faces the discharge end when the pump unit is secured to the discharge section, and wherein the latch is engageable with a fastener receiving surface located on a side of the container adjacent to the discharge section.

11. A pump unit for removably mounting to a discharge section of a container by way of a fastener, the pump unit comprising:
a pump housing including a pumping chamber defined therein; and
a fastener receiving surface;
wherein, when the pump housing is mounted to the discharge section of the container, the pumping chamber is in fluid communication with the discharge section of the container and the pump housing is secured to the discharge section by the fastener in a locked position with the fastener receiving surface; and
wherein, when the pump housing is removed from the discharge section of the container, the fastener is in an unlocked position with the fastener receiving surface.

12. The pump unit according to claim 11, wherein the pump housing includes a back pump section mountable to the discharge section, and a front pump section extending from the back pump section.

13. The pump unit according to claim 12 further comprising a first rotor rotatably located in a first rotor chamber, and a second rotor rotatably located in a second rotor chamber, wherein the first rotor chamber, the second rotor chamber and the pumping chamber are all in fluid communication with each other.

14. The pump unit according to claim 13 further comprising a seal in juxtaposition with the first rotor chamber, the second rotor chamber and the pumping chamber, the seal forming a sealed contact between the discharge section and the back pump section when the fastener is in the locked position.

15. The pump unit according to claim 13, wherein the front pump section includes a shaft extending into the second rotor chamber, the shaft rotatably locates the second rotor in the second rotor chamber.

16. The pump unit according to claim 13 further comprising a drive shaft configured to pass through a shaft bore defined through the front pump section and into the first rotor chamber, wherein the first rotor is attachable to a first end of the drive shaft that is operatively driven by a motor.

17. The pump unit according to claim 16 further comprising a first rotary seal located in the shaft bore and operatively engaged with the drive shaft, a bearing located in the shaft bore and operatively engaged with the drive shaft, and a second rotary seal located in the shaft bore and operatively engaged with the drive shaft, wherein the bearing is located between the first rotary seal and the second rotary seal.

18. The pump unit according to claim 17, wherein the drive shaft includes a stop ledge extending out therefrom and configured adjacent the bearing, and wherein a threaded member is configured to secure a cog or a cog socket to a second end of the drive shaft, the cog or the cog socket being operatively engageable with the motor.

19. The pump unit according to claim 11, wherein the fastener is a latch.

20. The pump unit according to claim 19, wherein the fastener receiving surface is on a side of the pump unit adjacent to a mounting side of the pump unit, the mounting side faces the discharge end when the pump unit is secured to the discharge section, and wherein the latch is on a side of the container adjacent to the discharge section, the latch is engageable with the fastener receiving surface.
